(19) United States
(12) Patent Application Publication
(10) Pub. No.: US 2017/0261591 A1
(43) Pub. Date: Sep. 14, 2017

(54) PACKET EXTENSIONS FOR RANGING OPERATIONS

(71) Applicant: QUALCOMM Incorporated, San Diego, CA (US)

(72) Inventors: Ning Zhang, Saratoga, CA (US); Xiaoxin Zhang, Sunnyvale, CA (US); Youhan Kim, San Jose, CA (US); Carlos Horacio Aldana, Mountain View, CA (US); Patrick Kelliher, Chelmsford, MA (US); Yen-Feng Lee, San Jose, CA (US)

(21) Appl. No.: 15/457,750

(22) Filed: Mar. 13, 2017

Related U.S. Application Data
(60) Provisional application No. 62/308,206, filed on Mar. 14, 2016.
(60) Provisional application No. 62/308,853, filed on Mar. 15, 2016.

(51) Int. Cl. G01S 5/02; G01S 5/06; G01S 11/04

(52) U.S. Cl. CPC G01S 5/0268; G01S 11/04; G01S 5/06; H04W 64/00

(57) ABSTRACT

This disclosure provides systems, methods and apparatuses for performing ranging operations between wireless devices. In some implementations, wireless devices can exchange ranging packets that include packet extensions containing a plurality of long training fields (LTFs). The wireless devices can use the LTFs in the ranging packets to obtain a plurality of round-trip time (RTT) values based on a single exchange of ranging packets. The wireless devices also can use the LTFs to estimate angle of arrival (AoA) and angle of departure (AoD) information of the exchanged ranging packets.

### CROSS-REFERENCE TO RELATED APPLICATIONS

This patent application claims priority to U.S. Provisional Patent Application No. 62/308,206 filed on Mar. 14, 2016 entitled “PACKET EXTENSIONS FOR RANGING OPERATIONS” and to U.S. Provisional Patent Application No. 62/308,853 filed on Mar. 15, 2016 entitled “PACKET EXTENSIONS FOR RANGING OPERATIONS,” both assigned to the assignee hereof. The disclosures of both prior applications are considered part of and are incorporated by reference in this patent application.

### TECHNICAL FIELD

This disclosure relates generally to wireless networks, and specifically to ranging operations performed between wireless devices.

### BACKGROUND OF RELATED ART

The recent proliferation of Wi-Fi® access points in wireless local area networks (WLANs) has made it possible for positioning systems to use these access points for position determination, especially in areas where there is a large concentration of active Wi-Fi access points (such as urban cores, shopping centers, office buildings, sporting venues, and so on). For example, a wireless device such as a cell phone or tablet computer may use the round-trip time (RTT) of signals exchanged with an access point (AP) to determine the distance between the wireless device and the AP. Once the distances between the wireless device and three APs having known locations are determined, the location of the wireless device may be determined using trilateration techniques.

Because ranging operations are becoming more important for position determination, it is desirable to increase the speed with which ranging operations may be performed while also increasing ranging accuracy. In addition, it is also desirable to increase the speed with which a wireless device may determine its position using ranging operations.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless network to perform ranging operations between a first wireless device and a second wireless device. The first wireless device can receive, from the second wireless device, a first ranging packet including a packet extension containing a plurality of first long training fields (LTFs). The first wireless device can transmit, to the second wireless device, an acknowledgement (ACK) including a packet extension containing a plurality of second LTFs. The first wireless device can receive, from the second wireless device, a second ranging packet containing timing information indicating a time of departure (TOD) value of the plurality of first LTFs in the first ranging packet and indicating a time of arrival (TOA) value of each of the plurality of second LTFs in the ACK. In some aspects, the first and second ranging packets can be high-efficiency (HE) packets containing fine timing measurement (FTM) frames. The first wireless device can determine a plurality of round-trip time (RTT) values based on a single exchange of the first ranging packet and the ACK. For example, in some aspects, a first of the plurality of RTT values can be based, at least in part, on the TOD value of the first LTFs and the TOA value of a first one of the plurality of second LTFs, and a second of the plurality of RTT values can be based, at least in part, on the TOD value of the first LTFs and the TOA value of a second one of the plurality of second LTFs. The first wireless device can estimate an angle of departure (AoD) or an angle of arrival (AoA) of the first ranging packet based, at least in part, on the plurality of first LTFs contained in the packet extension of the first ranging packet.

In some implementations, the plurality of first LTFs and the plurality of second LTFs can be high-efficiency long training fields (HE-LTFs). The HE-LTFs can be orthogonal to each other, and in some aspects can be based on (or derived from) a high-efficiency null data packet (HE NDP). Further, in some aspects, a preamble of the first ranging packet can be transmitted using a single antenna, and the packet extension of the first ranging packet can be transmitted using a plurality of antennas. Similarly, a preamble of the ACK can be transmitted using a single antenna, and the packet extension of the ACK can be transmitted using a plurality of antennas. In addition, the preamble of the first ranging packet can be transmitted as a single spatial stream, and the packet extension of the first ranging packet can be transmitted as a plurality of spatial streams. Similarly, the preamble of the ACK can be transmitted as a single spatial stream, and the packet extension of the ACK can be transmitted as a plurality of spatial streams.

Another innovative aspect of the subject matter described in this disclosure can be implemented as a method for performing ranging operations between wireless devices. The method can include receiving, from a wireless device, a first ranging packet including a packet extension containing a plurality of first long training fields (LTFs); transmitting, to the wireless device, an acknowledgement (ACK) including a packet extension containing a plurality of second LTFs; receiving, from the wireless device, a second ranging packet containing timing information indicating a time of departure (TOD) value of the plurality of first LTFs in the first ranging packet and indicating a time of arrival (TOA) value of each of the plurality of second LTFs in the ACK; and determining a plurality of round-trip time (RTT) values based on a single exchange of the first ranging packet and the ACK. In some aspects, the method also can include estimating an angle of departure (AoD) or an angle of arrival (AoA) of the first ranging packet based, at least in part, on the plurality of first LTFs contained in the packet extension of the first ranging packet.

Another innovative aspect of the subject matter described in this disclosure can be implemented in a non-transitory computer-readable medium. The non-transitory computer-readable medium can comprise instructions that, when executed by an apparatus, cause the apparatus to perform a ranging operation by receiving, from a wireless device, a first ranging packet including a packet extension containing a plurality of first long training fields (LTFs); transmitting, to the wireless device, an acknowledgement (ACK) including a packet extension containing a plurality of second LTFs; receiving, from the wireless device, a second ranging packet containing timing information indicating a time of departure (TOD) value of the plurality of first LTFs in the first ranging packet and indicating a time of arrival (TOA) value of each of the plurality of second LTFs in the ACK; and determining a plurality of round-trip time (RTT) values based on a single exchange of the first ranging packet and the ACK. In some aspects, execution of the instructions also can cause the apparatus to estimate an angle of departure (AoD) or an angle of arrival (AoA) of the first ranging packet based, at least in part, on the plurality of first LTFs contained in the packet extension of the first ranging packet.

Another innovative aspect of the subject matter described in this disclosure can be implemented in an apparatus. The apparatus can include one or more processors and a memory. The memory can store instructions that, when executed by the one or more processors, cause the apparatus to: receive, from a wireless device, a first ranging packet including a packet extension containing a plurality of first long training fields (LTFs); transmit, to the wireless device, an acknowledgement (ACK) including a packet extension containing a plurality of second LTFs; receive, from the wireless device, a second ranging packet containing timing information indicating a time of departure (TOD) value of the plurality of first LTFs in the first ranging packet and indicating a time of arrival (TOA) value of each of the plurality of second LTFs in the ACK; and determine a plurality of round-trip time (RTT) values based on a single exchange of the first ranging packet and the ACK. In some aspects, execution of the instructions also can cause the apparatus to estimate an angle of departure (AoD) or an angle of arrival (AoA) of the first ranging packet based, at least in part, on the plurality of first LTFs contained in the packet extension of the first ranging packet.

Another innovative aspect of the subject matter described in this disclosure can be implemented as a method for performing ranging operations. The method can include receiving, from a wireless device, a first ranging packet including a packet extension containing a plurality of first long training fields (LTFs); and estimating an angle of departure (AoD) or an angle of arrival (AoA) of the first ranging packet based, at least in part, on the plurality of first LTFs contained in the packet extension of the first ranging packet. In some implementations, the method also can include transmitting, to the wireless device, an acknowledgement (ACK) including a packet extension containing a plurality of second LTFs; and receiving, from the wireless device, a second ranging packet containing angle information of the ACK.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless system.

FIG. 2 shows a block diagram of an example wireless device.

FIG. 3 shows a signal diagram of an example ranging operation.

FIG. 4 shows a signal diagram of another example ranging operation.

FIG. 5A shows a signal diagram of an example ranging operation.

FIG. 5B shows a signal diagram depicting TOD and TOA values of individual long training fields of the example ranging operation of FIG. 5A.

FIG. 5C shows a sequence diagram depicting the example ranging operation of FIG. 5A.

FIG. 6A shows a signal diagram of another example ranging operation.

FIG. 6B shows a signal diagram depicting TOD and TOA values of individual long training fields of the example ranging operation of FIG. 6A.

FIG. 6C shows a sequence diagram depicting the example ranging operation of FIG. 6A.

FIG. 7A shows a signal diagram of another example ranging operation.

FIG. 7B shows a signal diagram depicting TOD and TOA values of individual long training fields of the example ranging operation of FIG. 7A.

FIG. 7C shows a sequence diagram depicting the example ranging operation of FIG. 7A.

FIG. 8A shows an example packet.

FIG. 8B shows an example high efficiency (HE) preamble.

FIG. 9A shows an example FTM Request frame.

FIG. 9B shows an example FTM action frame.

FIG. 9C shows an example acknowledgement (ACK) frame.

FIG. 10 shows an illustrative flow chart depicting an example ranging operation.

FIG. 11 shows an illustrative flow chart depicting another example ranging operation.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations of the subject matter described in this disclosure may be used to perform ranging operations between wireless devices. In some implementations, wireless devices can exchange ranging packets that include packet extensions containing a plurality of long training fields (LTFs). The wireless devices can use the plurality of LTFs contained in each of the packet extensions to obtain a plurality of round-trip time (RTT) values based on a single exchange of ranging packets. In some aspects, the packet extensions of the ranging packets can contain a plurality of high-efficiency long training fields (HE-LTFs). The HE-LTFs can be orthogonal to one another, for example, so that a receiving device can distinguish between HE-LTFs transmitted from different antennas or transmitted as different spatial streams. The wireless devices also can use the plurality of LTFs contained in the packet extensions of the ranging packets to estimate angle of arrival (AoA) and angle of departure (AoD) information of the exchanged ranging packets. The ranging packets can be high-efficiency (HE) packets having fine timing measurement (FTM) frames encapsulated therein. The FTM frames can be used by the wireless devices to exchange timing and angle information with each other. In addition, or in the alternative, a preamble of the ranging packets can contain a legacy long training field (L-LTF) and a HE-LTF. The wireless devices can determine additional RTT values based on pairs of L-LTFs in the preambles of the ranging packets and based on pairs of HE-LTFs in the preambles of the ranging packets.

In some implementations, the preambles, payloads, and packet extensions of the ranging packets may be transmitted using a single antenna of the wireless devices, for example, to avoid ranging errors resulting from cyclic shift diversity (CSD) associated with multi-antenna transmissions. In other implementations, the preambles and payloads of the ranging packets may be transmitted using a single antenna of the wireless devices, and the packet extensions of the ranging packets may be transmitted using multiple antennas of the wireless devices. Transmitting the packet extensions of the ranging packets using multiple antennas may allow the wireless devices to estimate angle of departure (AoD) information of the ranging packets, which in turn can allow one wireless device to determine its position by ranging another wireless device having a known location. In some other implementations, the preambles and payloads of the ranging packets may be transmitted as a single spatial stream, and the packet extensions of the ranging packets may be transmitted as multiple spatial streams.

Particular implementations of the subject matter described in this disclosure can be implemented to realize one or more of the following potential advantages. The ability to obtain a plurality of RTT values from each exchange of ranging packets not only can reduce the duration of a ranging operation but also can increase the accuracy of the ranging operation. For example, because a wireless device can obtain a plurality of RTT values from a single exchange of ranging packets, the wireless device can average out noise and eliminate outlier RTT values, which in turn can increase ranging accuracy. In addition, the ability to estimate angle information based on LTFs contained in ranging packets can allow ranging devices to determine an angular orientation (such as a line of bearing) with respect to each other. The determined angular orientation can be used in conjunction with the determined RTT values to determine the relative positions of the ranging devices. If the location of one of the ranging devices is known, then the location of the other ranging device can be determined without ranging additional devices or using trilateration techniques. As such the location of a wireless device can be determined with more accuracy in less time than conventional ranging operations.

The term “ranging frame,” as used herein, may refer to any frame, transmitted between two devices, that forms the basis of determining an RTT value indicative of a distance between the two devices. As used herein, the term “time value” may refer to a difference in time between a time of departure (TOD) of one frame from a given device and a time of arrival (TOA) of another frame at the given device, and the term “angle information” may refer to information indicating a direction of one device relative to another device and to information from which the direction of one device relative to another device may be derived.

Further, as used herein, the term “HT” may refer to a high throughput frame format or protocol defined, for example, by the IEEE 802.11n standards; the term “VHT” may refer to a very high throughput frame format or protocol defined, for example, by the IEEE 802.11ac standards; the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. Further, as used herein, the term “legacy ACK frame format” may refer to an ACK frame format defined by the IEEE 802.11a/g standards, and the term “non-legacy ACK frame format” may refer to an ACK frame format defined by the IEEE 802.11n/ac/ax standards and to high throughput ACK frame formats that may be defined in one or more future IEEE 802.11 standards.

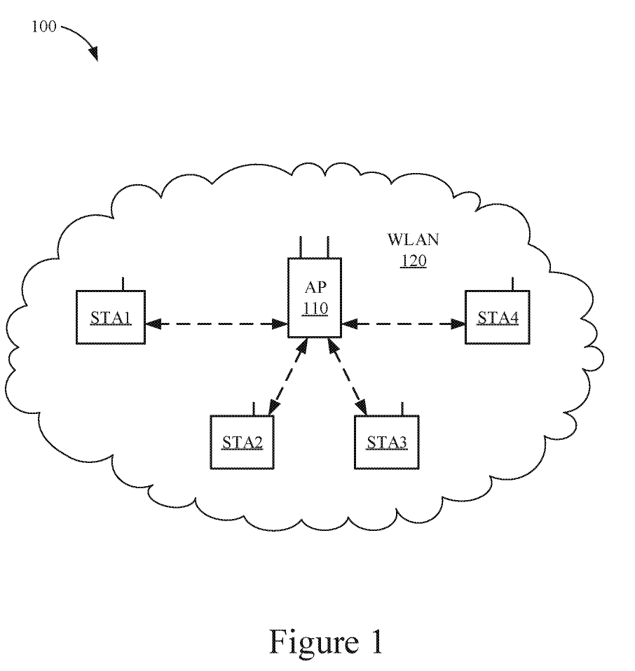

FIG. 1 shows a block diagram of a wireless system 100. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique media access control (MAC) address that is programmed therein by, for example, the manufacturer of the access point. Similarly, each of the stations STA1-STA4 is also assigned a unique MAC address. In some implementations, the wireless system 100 may correspond to a multiple-input multiple-output (MIMO) wireless network, and may support single-user MIMO (SU-MIMO) and multi-user (MU-MIMO) communications. Further, although the WLAN 120 is depicted in FIG. 1 as an infrastructure BSS, in some other implementations, the WLAN 120 may be an IBSS, an ad-hoc network, or a peer-to-peer (P2P) network (such as operating according to the Wi-Fi Direct protocols).

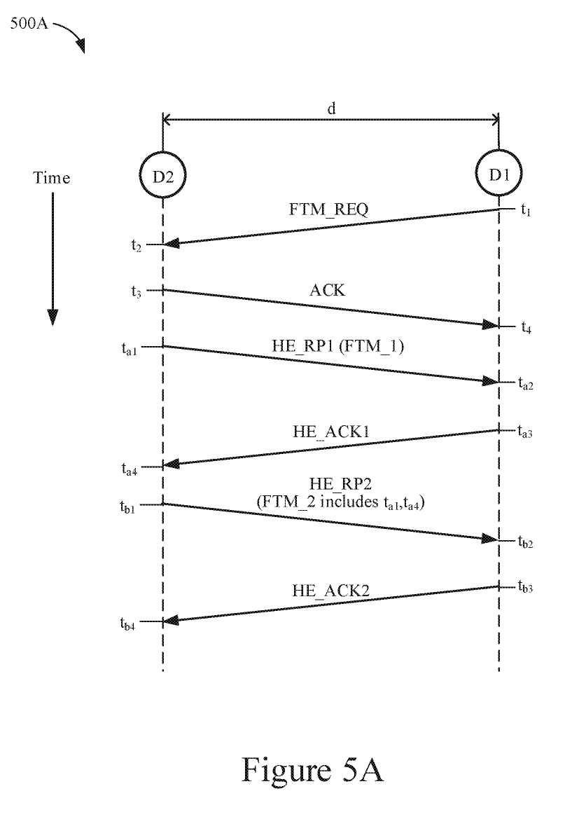

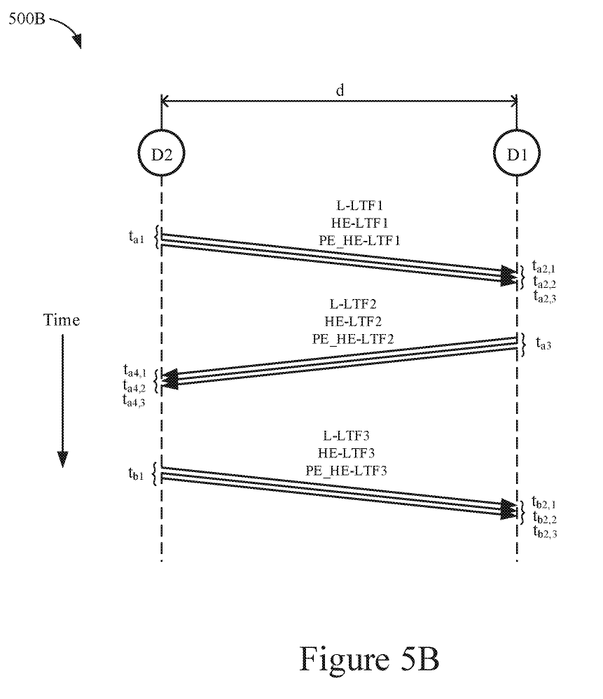

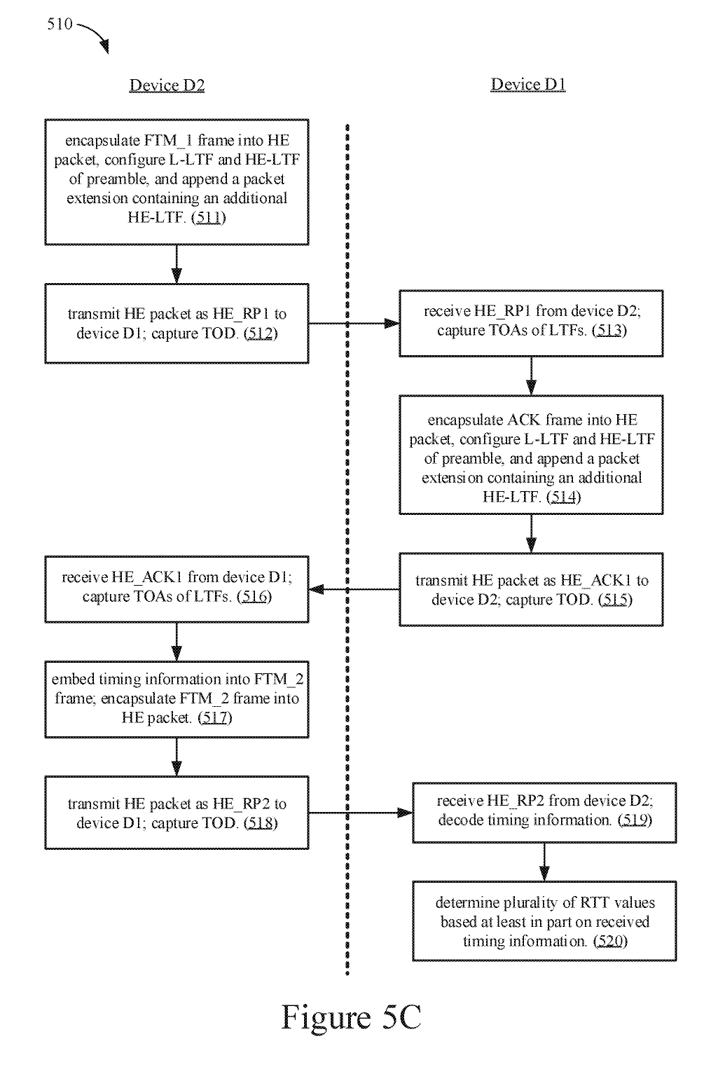

Each of the stations STA1-STA4 may be any suitable Wi-Fi enabled wireless device including, for example, a cell phone, personal digital assistant (PDA), tablet device, laptop computer, or the like. Each of the stations STA1-STA4 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of the stations STA1-STA4 may include one or more transceivers, one or more processing resources (such as processors and ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described with respect to FIGS. 5A-5C, 6A-6C, 7A-7C, and 10-11.

The AP 110 may be any suitable device that allows one or more wireless devices to connect to a network (such as a local area network (LAN), wide area network (WAN), metropolitan area network (MAN), and the Internet) via the AP 110 using Wi-Fi, Bluetooth, or any other suitable wireless communication standards. For at least some implementations, the AP 110 may include one or more transceivers, one or more processing resources (such as processors and ASICs), one or more memory resources, and a power source. The memory resources may include a non-transitory computer-readable medium (such as one or more nonvolatile memory elements, such as EPROM, EEPROM, Flash memory, a hard drive, etc.) that stores instructions for performing operations described with respect to FIGS. 5A-5C, 6A-6C, 7A-7C, and 10-11.

For the stations STA1-STA4 and the AP 110, the one or more transceivers may include Wi-Fi transceivers, Bluetooth transceivers, cellular transceivers, and other suitable radio frequency (RF) transceivers (not shown for simplicity) to transmit and receive wireless communication signals. Each transceiver may communicate with other wireless devices in distinct operating frequency bands and using distinct communication protocols. For example, the Wi-Fi transceiver may communicate within a 2.4 GHz frequency band, within a 5 GHz frequency band in accordance with the IEEE 802.11 specification, and within a 60 GHz frequency band. The cellular transceiver may communicate within various RF frequency bands in accordance with a 4G Long Term Evolution (LTE) protocol described by the 3rd Generation Partnership Project (3GPP) (such as between approximately 700 MHz and approximately 3.9 GHz) and in accordance with other cellular protocols (such as a Global System for Mobile (GSM) communications protocol). In other implementations, the transceivers included within each of the stations STA1-STA4 may be any technically feasible transceiver such as a ZigBee transceiver described by a specification from the ZigBee specification, a WiGig transceiver, and a HomePlug transceiver described a specification from the HomePlug Alliance.

For at least some implementations, each of the stations STA1-STA4 and the AP 110 may include radio frequency (RF) ranging circuitry (such as formed using well-known software modules, hardware components, or a suitable combination thereof) that may be used to estimate the distance between itself and another Wi-Fi enabled device and to determine the location of itself, relative to one or more other wireless devices, using ranging techniques described herein. In addition, each of the stations STA1-STA4 and the AP 110 may include a local memory (not shown in FIG. 1 for simplicity) to store a cache of Wi-Fi access point and station data.

Further, for some implementations, ranging operations described herein may be performed without using the AP 110, for example, by having a number of the stations operating in an ad-hoc or peer-to-peer mode, thereby allowing the stations to range one another even when outside the reception range of the AP 110 or a visible WLAN (or another wireless network). In addition, the ranging operations described herein may be performed between two APs that are in wireless range of each other.

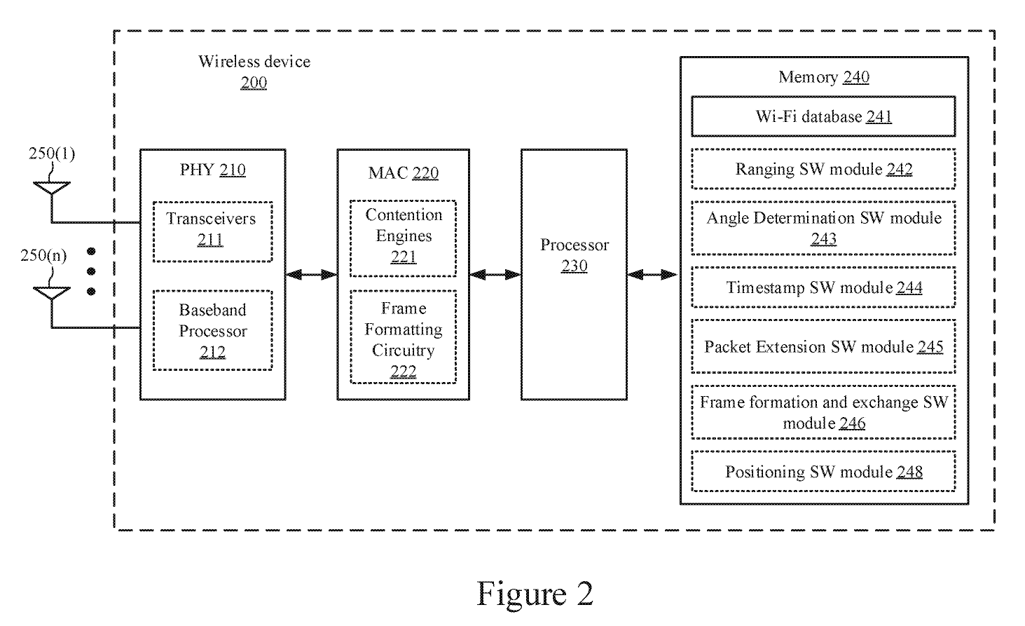

FIG. 2 shows a wireless device 200. The wireless device 200 may be one implementation of the stations STA1-STA4 and the AP 110 of FIG. 1. The wireless device 200 may include at least a physical-layer (PHY) device 210, a medium access controller (MAC) 220, a processor 230, a memory 240, and a number of antennas 250(1)-250(n). The PHY device 210 may include at least a number of transceivers 211 and a baseband processor 212. The transceivers 211 may be coupled to antennas 250(1)-250(n), either directly or through an antenna selection circuit (not shown for simplicity). The transceivers 211 may be used to transmit signals to and receive signals from the AP 110, other stations, and other suitable wireless devices (see also FIG. 1), and may be used to scan the surrounding environment to detect and identify nearby access points and other wireless devices (such as within wireless range of the wireless device 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for some implementations, the wireless device 200 may be configured for MIMO operations. The MIMO operations may include SU-MIMO operations and MU-MIMO operations.

The baseband processor 212 may be used to process signals received from the processor 230 and the memory 240 and to forward the processed signals to the transceivers 211 for transmission via one or more of the antennas 250(1)-250(n), and may be used to process signals received from one or more of the antennas 250(1)-250(n) via the transceivers 211 and to forward the processed signals to the processor 230 and the memory 240.

The MAC 220 may include at least a number of contention engines 221 and frame formatting circuitry 222. For purposes of discussion herein, the MAC 220 is shown in FIG. 2 as being coupled between the PHY device 210 and the processor 230. In actual implementations, the PHY device 210, the MAC 220, the processor 230, and the memory 240 may be connected together using one or more buses (not shown for simplicity).

The contention engines 221 may contend for access to one or more shared wireless mediums, and also may store packets for transmission over the one or more shared wireless mediums. In other implementations, the contention engines 221 may be separate from the MAC 220. For still other implementations, the contention engines 221 may be implemented as one or more software modules (such as stored in the memory 240 or stored in memory provided within the MAC 220) containing instructions that, when executed by the processor 230, perform the functions of the contention engines 221.

The frame formatting circuitry 222 may be used to create and format frames received from the processor 230 and the memory 240 (such as by adding MAC headers to PDUs provided by the processor 230), and may be used to re-format frames received from the PHY device 210 (such as by stripping MAC headers from frames received from the PHY device 210). In some aspects, the frame formatting circuitry 222 may be used to append a packet extension to packets to be transmitted from the wireless device 200. More specifically, one or more long training fields (LTFs), such as high efficiency long training fields (HE-LTFs), may be included within a packet extension that is appended to a packet (such as an HE packet). The packet, which may contain an encapsulated fine timing measurement (FTM) frame or an acknowledgement (ACK) frame, may then be used for ranging operations with another wireless device.

The memory 240 may include a Wi-Fi database 241 that may store location data, configuration information, data rates, MAC addresses, and other suitable information about (or pertaining to) a number of access points, stations, and other wireless devices. The Wi-Fi database 241 also may store profile information for a number of wireless devices. The profile information for a given wireless device may include information including, for example, the wireless device's service set identification (SSID), channel information, received signal strength indicator (RSSI) values, goodput values, channel state information (CSI), and connection history with the wireless device 200.

The memory 240 also may include a non-transitory computer-readable medium (such as one or more nonvolatile memory elements, such as EPROM, EEPROM, Flash memory, a hard drive, and so on) that may store the following software (SW) modules:
a ranging SW module 242 to initiate and perform a number of ranging operations with one or more devices and to determine RTT values and estimate distances based on the ranging operations, for example, as described for one or more operations of FIGS. 5A-5C, 6A-6C, 7A-7C, and 10-11;
an angle determination SW module 243 to determine angle of arrival (AoA) information of signals received by the wireless device 200 and to determine angle of departure (AoD) information of signals transmitted from another wireless device, for example, as described for one or more operations of FIGS. 5A-5C, 6A-6C, 7A-7C, and 10-11;
a timestamp SW module 244 to capture timestamps of signals received by wireless device 200 (such as TOA information) and to capture timestamps of signals transmitted from the wireless device 200 (such as TOD information), for example, as described for one or more operations of FIGS. 5A-5C, 6A-6C, 7A-7C, and 10-11;
a packet extension SW module 245 to embed one or more HE-LTFs into a packet extension and append the packet extension to an HE packet to be used during ranging operations performed between the wireless device 200 and one or more other devices and to decode HE-LTFs contained in packet extensions of received HE packets, for example, as described for one or more operations of FIGS. 5A-5C, 6A-6C, 7A-7C, and 10-11;
a frame formation and exchange SW module 246 to create, transmit, and receive frames to and from other wireless devices, to embed TOA information, TOD information, AoA information, and AoD information into selected frames or packets, and to create ranging packets that include a preamble containing one or more LTFs and that include a packet extension containing one or more additional LTFs, for example, as described for one or more operations of FIGS. 5A-5C, 6A-6C, 7A-7C, and 10-11; and
a positioning SW module 248 to determine the location of the wireless device 200 based, at least in part, on the distances determined by the ranging SW module 242 and the angle information determined by the angle determination SW module 243, for example, as described for one or more operations of FIGS. 5A-5C, 6A-6C, 7A-7C, and 10-11.

Each software module includes instructions that, when executed by the processor 230, cause the wireless device 200 to perform the corresponding functions. The non-transitory computer-readable medium of the memory 240 thus includes instructions for performing all or a portion of the operations of FIGS. 5A-5C, 6A-6C, 7A-7C, and 10-11.

The processor 230 may be one or more suitable processors capable of executing scripts or instructions of one or more software programs stored in the wireless device 200 (such as within the memory 240). For example, the processor 230 may execute the ranging SW module 242 to initiate and perform a number of ranging operations with one or more devices and to determine RTT values and estimate distances based on the ranging operations.

The processor 230 may execute the angle determination SW module 243 to determine AoA information of signals received by the wireless device 200 and to determine AoD information of signals transmitted from another wireless device.

The processor 230 may execute the timestamp SW module 244 to capture timestamps of signals received by the wireless device 200 (such as TOA information) and to capture timestamps of signals transmitted from wireless device 200 (such as TOD information).

The processor 230 may execute the packet extension SW module 245 to embed one or more HE-LTFs into a packet extension and append the packet extension to an HE packet to be used during ranging operations performed between the wireless device 200 and one or more other devices and to decode HE-LTFs contained in packet extensions of received HE packets.

The processor 230 may execute the frame formation and exchange SW module 246 to create, transmit, and receive frames to and from other wireless devices, to embed TOA information, TOD information, AoA information, and AoD information into selected frames or packets, and to create ranging packets that include a preamble containing one or more LTFs and that include a packet extension containing one or more additional LTFs.

The processor 230 may execute the positioning SW module 248 to determine the location of the wireless device 200 based, at least in part, on the distances determined by the ranging SW module 242 and the angle information determined by the angle determination SW module 243.

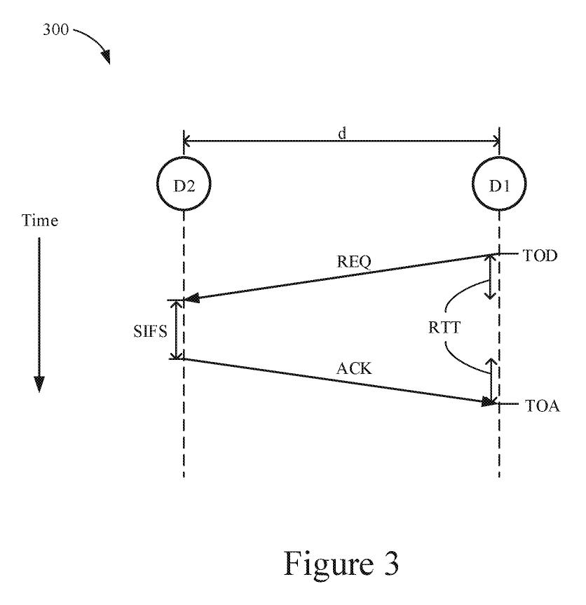

The distance between a pair of devices may be determined using the RTT of signals exchanged between the devices. For example, FIG. 3 shows a signal diagram of an example ranging operation 300. The example ranging operation 300 is performed between a first device D1 and a second device D2. The distance (d) between the first device D1 and the second device D2 may be estimated as d=c*RTT/2, where c is the speed of light, and RTT is the summation of the actual signal propagation times of a request (REQ) frame and an acknowledgement (ACK) frame exchanged between device D1 and device D2. Device D1 and device D2 may each be, for example, an access point (such as the AP 110 of FIG. 1), a station (such as one of the stations STA1-STA4 of FIG. 1), or another suitable wireless device (such as the wireless device 200 of FIG. 2).

More specifically, device D1 may estimate the RTT between itself and device D2 using the time of departure (TOD) of the REQ frame transmitted from device D1, the time of arrival (TOA) of the ACK frame received by device D1, and the short interframe space (SIFS) duration of device D2. The SIFS duration may indicate the duration of time between device D2 receiving the REQ frame and transmitting the ACK frame. The SIFS duration, a range of values for which are provided by the IEEE 802.11 standards, provides Wi-Fi enabled devices time to switch their transceivers from a receive mode (such as to receive the REQ frame) to a transmit mode (such as to transmit the ACK frame).

Because different make-and-models (and sometimes even same make-and-models) of communication devices have different processing delays, the precise value of SIFS may vary between devices (and even between successive frame receptions/transmissions in the same device). As a result, the value of SIFS is typically estimated, which often leads to errors in estimating the distance between two devices. More specifically, the IEEE 802.11 standards define the SIFS duration as 10 us+/−900 ns at 2.4 GHz, 16 us+/−900 ns at 5 GHz, and 3 us+/−900 ns at 60 GHz. These “standard” SIFS durations include tolerances that may decrease the accuracy of RTT estimates. For example, even if the SIFS duration of device D2 may be estimated within +/−25 ns, a ranging error of +/−7.5 meters may result (which may be unacceptable for many positioning systems).

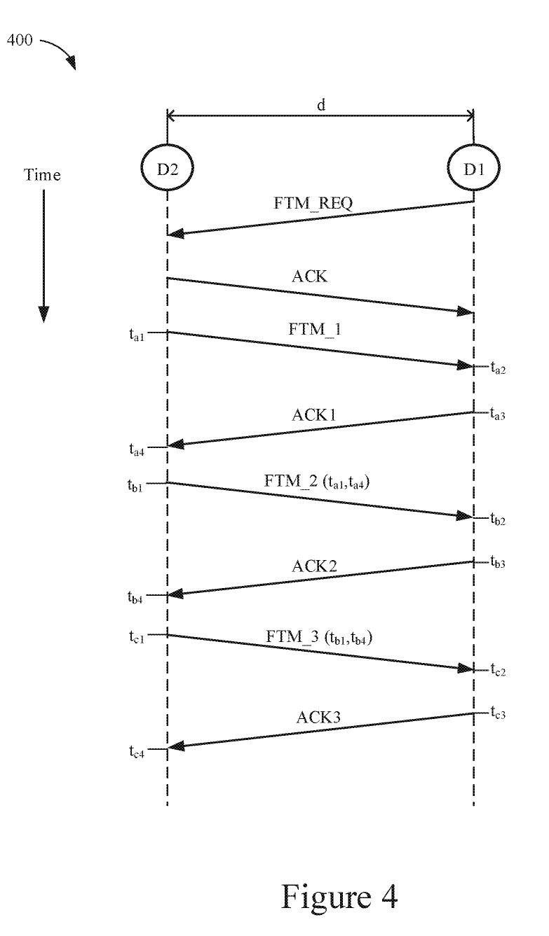

To reduce ranging errors resulting from uncertainties in the value of SIFS, recent revisions to the IEEE 802.11 standards call for each ranging device to capture timestamps of incoming and outgoing frames so that the value of RTT may be determined without using SIFS. For example, FIG. 4 shows a signal diagram of another example ranging operation 400. The example ranging operation 400 is performed between device D1 and device D2 using Fine Timing Measurement (FTM) frames in accordance with the IEEE 802.11REVmc standards. Device D1 and device D2 may each be, for example, an access point (such as the AP 110 of FIG. 1), a station (such as one of the stations STA1-STA4 of FIG. 1), or other suitable wireless device (such as the wireless device 200 of FIG. 2). For the example of FIG. 4, device D1 requests the ranging operation; thus, device D1 is the initiator device (or alternatively the requestor device) and device D2 is the responder device. Note that the term “initiator device” also may refer to an initiator STA, and the term “responder device” also may refer to a responder STA.

Device D1 may request or initiate the ranging operation by transmitting an FTM request (FTM_REQ) frame to device D2. The FTM_REQ frame also may include a request for device D2 to capture timestamps (such as TOA information) of frames received by device D2 and to capture timestamps (such as TOD information) of frames transmitted from device D2. Device D2 receives the FTM_REQ frame, and may acknowledge the requested ranging operation by transmitting an acknowledgement (ACK) frame to device D1. The ACK frame may indicate whether device D2 is capable of capturing the requested timestamps. It is noted that the exchange of the FTM_REQ frame and the ACK frame is a handshake process that not only signals an intent to perform a ranging operation but also allows devices D1 and D2 to determine whether each other supports capturing timestamps.

At time tₐ₁, device D2 transmits a first FTM (FTM_1) frame to device D1, and may capture the TOD of the FTM_1 frame as time tₐ₁. Device D1 receives the FTM_1 frame at time tₐ₂, and may capture the TOA of the FTM_1 frame as time tₐ₂. Device D1 responds by transmitting a first FTM acknowledgement (ACK1) frame to device D2 at time tₐ₃, and may capture the TOD of the ACK1 frame as time tₐ₃. Device D2 receives the ACK1 frame at time tₐ₄, and may capture the TOA of the ACK1 frame at time tₐ₄. At time t_{b1}, device D2 transmits to device D1 a second FTM (FTM_2) frame that includes the timestamps captured at times tₐ₁ and tₐ₄ (such as the TOD of the FTM_1 frame and the TOA of the ACK1 frame). Device D1 receives the FTM_2 frame at time t_{b2}, and may capture its timestamp as time t_{b2}.

Upon receiving the FTM_2 frame at time t_{b2}, device D1 has timestamp values for times tₐ₁, tₐ₂, tₐ₃, and tₐ₄ that correspond to the TOD of the FTM_1 frame transmitted from device D2, the TOA of the FTM_1 frame at device D1, the TOD of the ACK1 frame transmitted from device D1, and the TOA of the ACK1 frame at device D2, respectively. Thereafter, device D1 may determine a first RTT value as RTT₁=(tₐ₄−tₐ₃)+(tₐ₂−tₐ₁). Because the value of RTT₁ does not involve estimating SIFS for either device D1 or device D2, the value of RTT₁ does not involve errors resulting from uncertainties of SIFS durations. Consequently, the accuracy of the resulting estimate of the distance between devices D1 and D2 is improved (such as compared to the ranging operation 300 of FIG. 3).

As depicted in FIG. 4, devices D1 and D2 are shown to exchange an additional pair of FTM and ACK frames from which an additional RTT value may be determined. Specifically, at time t_{b3}, device D1 may transmit a second FTM acknowledgement (ACK2) frame to device D2 (such as to acknowledge reception of the FTM_2 frame). Device D2 receives the ACK2 frame at time t_{b4}, and may record the TOA of the ACK2 frame as time t_{b4}. At time t_{c1}, device D2 transmits to device D1 a third FTM (FTM_3) frame that includes the timestamps captured at times t_{b1} and t_{b4} (such as the TOD of the FTM_2 frame and the TOA of the ACK2 frame). Device D1 receives the FTM_3 frame at time t_{c2}, and may capture its timestamp as time t_{c2}. Device D1 may respond by transmitting a third FTM acknowledgement (ACK3) frame to device D2 at time t_{c3}.

Upon receiving the FTM_3 frame at time t_{c2}, device D1 has timestamp values for times t_{b1}, t_{b2}, t_{b3}, and t_{b4} that correspond to the TOD of the FTM_2 frame transmitted from device D2, the TOA of the FTM_2 frame at device D1, the TOD of the ACK2 frame transmitted from device D1, and the TOA of the ACK2 frame at device D2, respectively. Thereafter, device D1 may determine a second RTT value as RTT₂=(t_{b4}−t_{b3})+(t_{b2}−t_{b1}). This process may continue for any number of subsequent FTM and ACK frame exchanges between devices D1 and D2, for example, where device D2 embeds the timestamps of a given FTM and ACK frame exchange into a subsequent FTM frame transmitted to device D1.

The accuracy of the RTT estimate between device D1 and device D2 may be proportional to the frequency bandwidth (such as the channel width) used for transmitting the FTM and ACK frames. As a result, ranging operations for which the FTM and ACK frames are transmitted using a relatively large frequency bandwidth may be more accurate than ranging operations for which the FTM and ACK frames are transmitted using a relatively small frequency bandwidth. For example, ranging operations performed using FTM frame exchanges on an 80 MHz-wide channel are more accurate than ranging operations performed using FTM frame exchanges on a 40 MHz-wide channel, which in turn are more accurate than ranging operations performed using FTM frame exchanges on a 20 MHz-wide channel.

In addition, because Wi-Fi ranging operations are typically performed using frames transmitted as orthogonal frequency-division multiplexing (OFDM) symbols, the accuracy of RTT estimates may be proportional to the number of tones (such as the number of OFDM sub-carriers) used to transmit the FTM and ACK frames between ranging devices. For example, while a legacy (such as non-HT) frame may be transmitted on a 20 MHz-wide channel using 52 tones, an HT frame or VHT frame may be transmitted on a 20 MHz-wide channel using 56 tones, and an HE frame may be transmitted on a 20 MHz-wide channel using 242 tones. Thus, for a given frequency bandwidth or channel width, HT/VHT/HE frames use more tones than non-HT frames, and may therefore provide more accurate channel estimates and RTT estimates than non-HT frames. Accordingly, ranging operations performed with HT/VHT/HE frames may be more accurate than ranging operations performed with non-HT frames.

The IEEE 802.11REVmc standards allow FTM frames (such as the FTM_1 frame, the FTM_2 frame, and the FTM_3 frame of the example ranging operation 400 of FIG. 4) to be transmitted using the legacy (such as non-HT) format, the HT format, and the VHT format. The IEEE 802.11REVmc standards may not support FTM frame transmissions in the HE format, and do not specify any particular format or protocol for ACK frames transmitted during ranging operations. Because packets transmitted using the HE format use more tones than packets transmitted using the HT format or the VHT format, ranging accuracy may be improved by encapsulating FTM frames and ACK frames into HE packets for ranging operations.

FIG. 5A shows a signal diagram 500A of an example ranging operation, FIG. 5B shows a signal diagram 500B depicting TOD and TOA values of individual LTFs of the example ranging operation of FIG. 5A, and FIG. 5C shows a sequence diagram 510 depicting the example ranging operation of FIG. 5A. The example ranging operation depicted in FIGS. 5A-5C may be performed between a first device D1 and a second device D2. Device D1 and device D2 each may be, for example, an access point (such as the AP 110 of FIG. 1), a station (such as one of the stations STA1-STA4 of FIG. 1), or another suitable wireless device (such as the wireless device 200 of FIG. 2). The example ranging operation of FIG. 5A may allow device D1 to obtain a plurality of RTT measurement from each exchange of FTM and ACK frames, thereby allowing device D1 to simultaneously, or substantially simultaneously, determine a plurality of RTT values indicative of the distance (d) between devices D1 and device D2 from a single FTM/ACK frame exchange. The plurality of RTT values be may combined (such as averaged) to offset noise and erroneous RTT values, for example, to increase ranging accuracy.

As mentioned, ranging operations performed in accordance with the subject matter described in this disclosure may use HE packets to transmit the FTM frames and ACK frames. As used herein, a HE packet containing an encapsulated FTM frame may be referred to as a “HE ranging packet,” and an HE packet containing an encapsulated ACK frame may be referred to as a “HE ACK packet.”

Further, for the example ranging operation depicted in FIGS. 5A and 5B, device D2 transmits HE ranging packets using a single antenna, and device D1 transmits HE ACK packets using a single antenna.

At time t₁, device D1 may request or initiate the ranging operation by transmitting an FTM request (FTM_REQ) to device D2. The FTM_REQ also may include a request for device D2 to capture timestamps (such as TOA information of frames received by device D2 and TOD information of frames transmitted from device D2). Device D2 receives the FTM_REQ at time t₂, and may acknowledge the requested ranging operation by transmitting an acknowledgement (ACK) to device D1 at time t₃. The ACK may indicate whether device D2 is capable of capturing the requested timestamps. Device D1 may receive the ACK at time t₄. After this handshake process, the ranging operation between device D1 and device D2 may begin.

Device D2 may encapsulate a first FTM frame (FTM_1) into a first HE packet, configure the L-LTF and the HE-LTF of the preamble of the first HE packet (such as for ranging operations), and append a packet extension containing an additional HE-LTF to the first HE packet (511). Then, at time tₐ₁, device D2 may transmit the first HE packet as a first HE ranging packet (HE_RP1) to device D1, and may capture the TOD of HE_RP1 as time tₐ₁ (512).

Device D1 receives HE_RP1 at time tₐ₂, and may capture the TOA of HE_RP1 as time tₐ₂, (513). In some aspects, device D1 may capture the TOAs of the L-LTF and HE-LTF in the preamble of HE_RP1, and may capture the TOA of the HE-LTF in the packet extension of HE_RP1. The L-LTF, the HE-LTF, and the packet extension HE-LTF may have different TOA values. For example, referring to FIG. 5B, L-LTF1 may have a TOA of t_{a2,1}, HE-LTF1 may have a TOA of t_{a2,2}, and PE_HE-LTF1 may have a TOA of t_{a2,3}.

Device D1 may encapsulate a first ACK frame into a second HE packet, configure the L-LTF and the HE-LTF of the preamble of the second HE packet, and append a packet extension containing an additional HE-LTF to the second HE packet (514). Then, at time tₐ₃, device D1 may transmit the second HE packet as a first HE ACK packet (HE_ACK1) to device D2, and may capture the TOD of HE_ACK1 as time tₐ₃ (515).

Device D2 receives HE_ACK1 at time tₐ₄, and may capture the TOA of HE_ACK1 at time tₐ₄ (516). In some aspects, device D2 may capture the TOAs of the L-LTF and HE-LTF in the preamble of HE_ACK1, and may capture the TOA of the HE-LTF in the packet extension of HE_ACK1. The L-LTF, the HE-LTF, and the packet extension HE-LTF may have different TOA values. For example, referring to FIG. 5B, L-LTF2 may have a TOA of t_{a4,1}, HE-LTF2 may have a TOA of t_{a4,2}, and PE_HE-LTF2 may have a TOA of t_{a4,3}.

Device D2 may embed timing information associated with the TOD of HE_RP1 and the TOA of HE_ACK1 into a second FTM frame (FTM_2), and encapsulate the second FTM frame into a third HE packet (517). The timing information may be indicative of the TOD of the FTM_1 frame encapsulated in HE_RP1 and the TOA of the ACK1 frame encapsulated in HE_ACK1. In some aspects, the TOA (tₐ₄) reported by device D2 to device D1 may be based on (such as an average of) the TOAs of L-LTF2, HE-LTF2, and PE_LTF2 received with the ACK1 frame (device D2 may use any suitable algorithm for selecting an accurate TOA value for tₐ₄).

Then, at time t_{b1}, device D2 may transmit the third HE packet as a second HE ranging packet (HE_RP2) to device D1 (518). In some implementations, device D2 may capture the TOD of HE_RP2 as time t_{b1}.

Device D1 receives HE_RP2 at time t_{b2}, and decodes the timing information embedded therein (519). In some implementations, device D1 may capture the TOA of HE_RP2 as time t_{b2}. In some aspects, device D1 may capture the TOAs of the L-LTF and HE-LTF in the preamble of HE_RP2, and may capture the TOA of the HE-LTF in the packet extension of HE_RP2. The L-LTF, the HE-LTF, and the packet extension HE-LTF may have different TOA values. For example, referring to FIG. 5B, L-LTF3 may have a TOA of t_{b2,1}, HE-LTF3 may have a TOA of t_{b2,2}, and PE_HE-LTF3 may have a TOA of t_{b2,3}.

Upon receiving HE_RP2 at time t_{b2}, device D1 has a timestamp value for time tₐ₁ that corresponds to the TOD of HE_RP1 transmitted from device D2, has timestamp values for times t_{a2,1}-t_{a2,3} that correspond to the TOAs of L-LTF1, HE-LTF1, and PE_HE-LTF1 in HE_RP1 received at device D1, has a timestamp value for time tₐ₃ that corresponds to the TOD of HE_ACK1 transmitted from device D1, and has a timestamp value for time tₐ₄ that corresponds to the TOA of the ACK1 frame encapsulated in HE_ACK1.

Thereafter, device D1 may determine a plurality of RTT values based on the timestamp values tₐ₁, t_{a2,1}, t_{a2,3}, tₐ₃, and tₐ₄ (520). More specifically, device D1 may determine a first RTT value based on the exchange of L-LTF1 and L-LTF2 as RTT1=(tₐ₄, −tₐ₃)+(t_{a2,1}−tₐ₁), may determine a second RTT value based on the exchange of HE-LTF1 and HE-LTF2 as RTT2=(tₐ₄, −tₐ₃)+(t_{a2,2}−tₐ₁), and may determine a third RTT value based on the exchange of PE_HE-LTF1 and PE_HE-LTF2 as RTT3=(tₐ₄, −tₐ₃) (t_{a2,3}−tₐ₁).

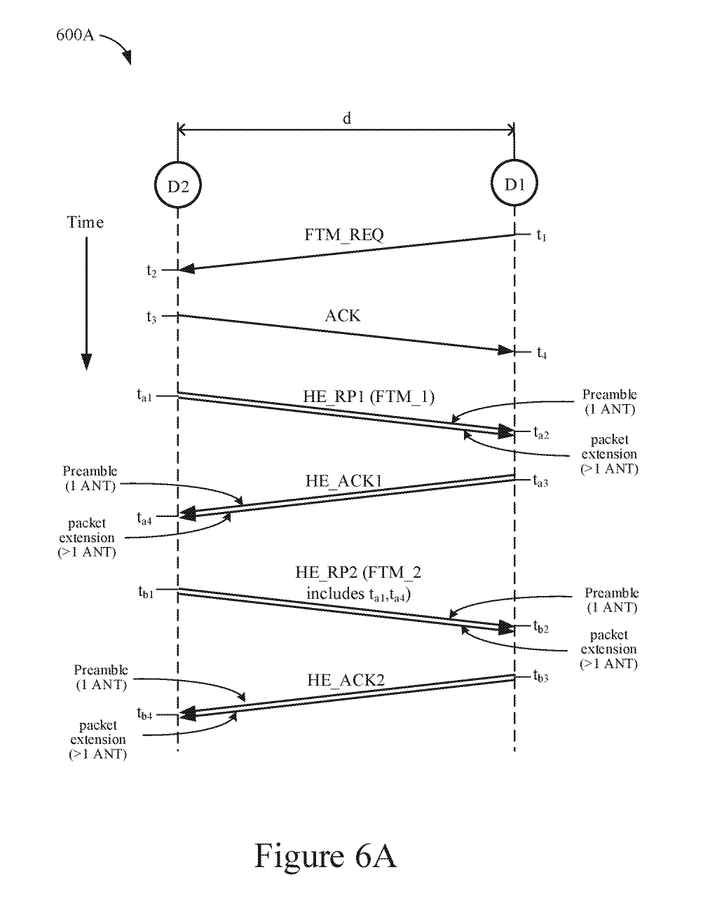

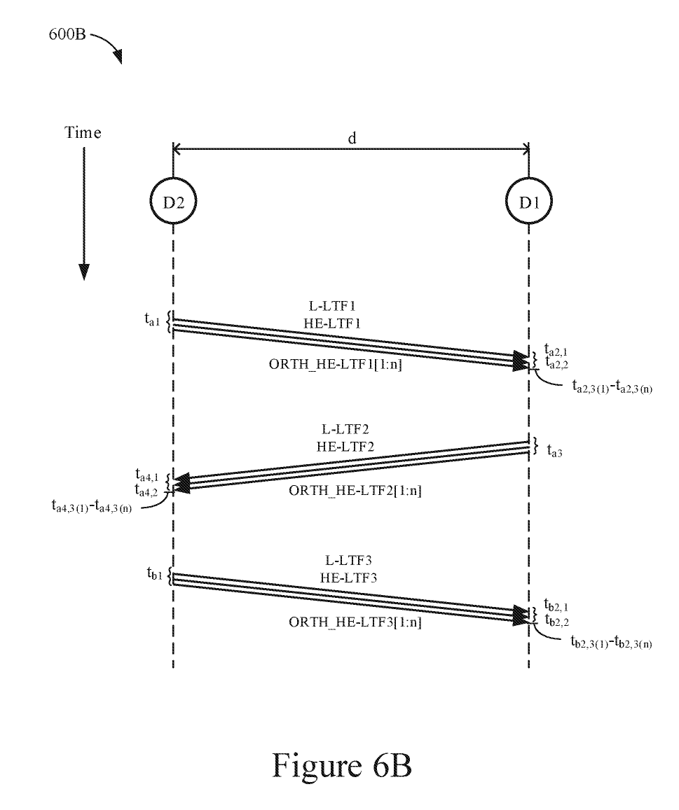

FIG. 6A shows a signal diagram 600A of another example ranging operation, FIG. 6B shows a signal diagram 600B depicting TOD and TOA values of individual LTFs of the example ranging operation of FIG. 6A, and FIG. 6C shows a sequence diagram 610 depicting the example ranging operation of FIG. 6A. The example ranging operation depicted in FIGS. 6A-6C may be performed between a first device D1 and a second device D2. Device D1 and device D2 may each be, for example, an access point (such as the AP 110 of FIG. 1), a station (such as one of stations STA1-STA4 of FIG. 1), or another suitable wireless device (such as the wireless device 200 of FIG. 2). The example ranging operation of FIG. 6A is similar to the example ranging operation of FIG. 5A, except that for the example ranging operation of FIG. 6A, the preamble and payload of HE packets may be transmitted using a single antenna, and the packet extension of HE packets may be transmitted using a plurality of antennas.

More specifically, for the example ranging operation of FIG. 6A, device D2 may transmit the preambles and payload of HE ranging packets using a single one of its antennas, and may transmit the packet extensions of HE ranging packets using a plurality of its antennas. In a similar manner, device D1 may transmit the preambles and payload of HE ACK packets using a single one of its antennas, and may transmit the packet extensions of HE ACK packets using a plurality of its antennas. By transmitting the packet extensions of HE packets using multiple antennas during the example ranging operation of FIG. 6A, device D1 may estimate AoD information for the HE ranging packets transmitted from device D2, and device D2 may estimate AoD information for the HE ACK packets transmitted from device D1.

After the handshake process between times t₁ and t₄ (such as described with respect to FIG. 5A), device D1 and device D2 may begin the ranging operation. Specifically, device D2 may encapsulate the FTM_1 frame into a first HE ranging packet (HE_RP1), configure the L-LTF and the HE-LTF of the preamble of HE_RP1, and append a packet extension containing a plurality of orthogonal HE-LTFs to HE_RP1 (611). In some aspects, the plurality of orthogonal HE-LTFs may be copies of the HE-LTFs defined for HE NDPs.

Then, at time tₐ₁, device D2 may transmit the preamble and payload of HE_RP1 using a single antenna, may transmit the packet extension of HE_RP1 using a plurality of antennas, and may capture the TOD of HE_RP1 as time tₐ₁ (612). More specifically, as depicted in FIG. 6B, device D2 may transmit the L-LTF and the HE-LTF of HE_RP1's preamble using a single antenna, and may transmit the plurality of orthogonal HE-LTFs in HE_RP1's packet extension using the plurality of antennas.

Device D1 receives HE_RP1 at time tₐe, may capture the TOA of HE_RP1 as time tₐ₂, and may estimate AoD information of HE_RP1 (613). Even if device D1 uses a single antenna to receive the plurality of HE-LTFs in the packet extension of HE_RP1, device D1 may distinguish between the channels associated with the different transmit antennas of device D2, for example, because the HE-LTFs are orthogonal to each other. By using the channels associated with the different transmit antennas of device D2, device D1 can estimate AoD information of HE_RP1. In some aspects, device D1 can use the HE-LTFs in the packet extension of HE_RP1 to estimate channel conditions between device D1 and device D2, and can derive AoD information of HE_RP1 from the estimated channel conditions.

In some aspects, device D1 may capture the TOAs of the L-LTF and HE-LTF in the preamble of HE_RP1, and may capture the TOAs of ORTH_HE-LTF1[1:n] in the packet extension of HE_RP1. The L-LTF, the HE-LTF, and the plurality of orthogonal HE-LTFs may have different TOA values. For example, referring to FIG. 6B, L-LTF1 may have a TOA of t_{a2,1}, HE-LTF1 may have a TOA of t_{a2,2}, and ORTH_HE-LTF1[1:n] may have respective TOAs of t_{a2,3(1)}-t_{a2,3(n)}. In addition, because the plurality of orthogonal HE-LTFs in the packet extension of HE_RP1 were transmitted using multiple antennas of device D2, device D1 may estimate the AoD of HE_RP1 from device D2. Further, if device D1 uses multiple antennas to receive HE_RP1, then device D1 can estimate AoA information of HE_RP1.

Device D1 may encapsulate an ACK1 frame into HE_ACK1, configure the L-LTF and the HE-LTF of the preamble of HE_ACK1, and append a packet extension containing a plurality of orthogonal HE-LTFs to HE_ACK1 (614). In some aspects, the plurality of orthogonal HE-LTFs may be copies of the HE-LTFs defined for HE NDPs.

Then, at time tₐ₃, device D1 may transmit the preamble and payload of HE_ACK1 using a single antenna, may transmit the packet extension of HE_ACK1 using a plurality of antennas, and may capture the TOD of HE_ACK1 as time tₐ₃ (615). More specifically, as depicted in FIG. 6B, device D1 may transmit the L-LTF and the HE-LTF of HE_ACK1's preamble using a single antenna, and may transmit each of the plurality of orthogonal HE-LTFs in HE_ACK1's packet extension using the plurality of antennas.

Device D2 receives HE_ACK1 at time tₐ₄, may capture the TOA of HE_ACK1 at time tₐ₄, and may estimate the AoD (616). In some aspects, device D2 may capture the TOAs of the L-LTF and HE-LTF in the preamble of HE_ACK1, and may capture the TOAs of the HE-LTF in the packet extension of HE_ACK1. The L-LTF, the HE-LTF, and the plurality of orthogonal HE-LTFs associated with HE_ACK1 may have different TOA values. For example, referring to FIG. 6B, L-LTF2 may have a TOA of t_{a4,1}, HE-LTF2 may have a TOA of t_{a4,2}, and ORTH_HE-LTF2[1:n]) may have respective TOAs of t_{a4,3(1)}-t_{a4,3(n)}. In addition, because the plurality of orthogonal HE-LTFs in the packet extension of HE_ACK1 were transmitted using multiple antennas of device D1, device D2 may estimate the AoD of HE_ACK1 from device D1. The orthogonal HE-LTFs associated with HE_ACK1 may have different TOA values, for example, as described with respect to FIG. 6B.

Device D2 may embed timing information and angle information into an FTM_2 frame, and encapsulate the FTM_2 frame into HE_RP2 (617). The timing information may be indicative of the TOD of the FTM_1 frame encapsulated in HE_RP1 and the TOA of the ACK1 frame encapsulated in HE_ACK1. In some aspects, the TOA (tₐ₄) reported by device D2 to device D1 may be based on (such as an average of) the TOAs of L-LTF2, HE-LTF2, and ORTH_HE-LTF2[1:n] received with the ACK1 frame encapsulated in HE_ACK1 (device D2 may use any suitable algorithm for selecting an accurate TOA value for tₐ₄). The angle information may include the estimated AoD of HE_ACK1 transmitted from device D1. In some aspects, the angle information also may include the estimated AoA of HE_ACK1 received at device D2 (such as if device D2 uses multiple antennas to receive HE_ACK1).

Then, at time t_{b1}, device D2 may transmit the preamble and payload of HE_RP2 using a single antenna, may transmit the packet extension of HE_RP2 using a plurality of antennas, and may capture the TOD of HE_RP2 as time t_{b1} (618). More specifically, as depicted in FIG. 6B, device D2 may transmit the L-LTF and the HE-LTF of HE_RP2's preamble using a single antenna, and may transmit each of the plurality of orthogonal HE-LTFs in HE_RP2's packet extension using the plurality of antennas.

Device D1 receives HE_RP2 at time t_{b2}, and decodes the timing information and the angle information embedded therein (619). In some implementations, device D1 may capture the TOA of HE_RP2 as time t_{b2}. In some aspects, device D1 may capture the TOAs of the L-LTF and HE-LTF in the preamble of HE_RP2, and may capture the TOA of the plurality of orthogonal HE-LTFs in the packet extension of HE_RP2. The L-LTF, the HE-LTF, and the plurality of orthogonal HE-LTFs associated with HE_RP2 may have different TOA values. For example, as depicted in FIG. 6B, L-LTF2 may have a TOA of t_{b2,1}, HE-LTF2 may have a TOA of t_{b2,2}, and ORTH_HE-LTF2[1:n] may have respective TOAs of t_{b2,3(1)}-t_{b2,3(n)}.

Upon receiving HE_RP2 at time t_{b2}, device D1 has a timestamp value for time tₐ₁ that corresponds to the TOD of HE_RP1 transmitted from device D2, has timestamp values for times t_{a2,1}, t_{a2,2}, and t_{a2,3(1)}-t_{a2,3(n)} that correspond to the TOAs of L-LTF1, HE-LTF1, and ORTH_HE-LTF1[1:n] in HE_RP1 received at device D1, has a timestamp value for time tₐ₃ that corresponds to the TOD of HE_ACK1 transmitted from device D1, and has a timestamp value for time tₐ₄ that corresponds to the TOA of the ACK1 frame encapsulated in HE_ACK1.

Thereafter, device D1 may determine a plurality of RTT values based on the aforementioned timestamp values, and may determine its direction relative to device D2 (such as based on the AoA or AoD information embedded in the FTM_2 frame) (620). More specifically, device D1 may determine a first RTT value based on the exchange of L-LTF1 and L-LTF2 as RTT1=(tₐ₄−tₐ₃)+(t_{a2,1}−tₐ₁), may determine a second RTT value based on the exchange of HE-LTF1 and HE-LTF2 as RTT2=(tₐ₄−tₐ₃)+(t_{a2,2}−tₐ₁), and may determine an additional plurality of RTT values based on pairs of the plurality of ORTH_HE-LTF1[1:n] and ORTH_HE-LTF2[1:n].

Because device D1 may estimate the distance to device D2 (such as based on the plurality of RTT values) as well as its direction relative to device D2 (such as based on the AoA or AoD information embedded in the FTM_2 frame), device D1 may estimate its location relative to device D2. If the actual location of device D2 is known, then device D1 may determine its actual location based on the known location of device D2 and its location relative to device D2.

It is noted that because devices D1 and D2 each transmit the preambles and payload of HE packets using a single antenna and each transmit the packet extensions of HE packets using multiple antennas, each of devices D1 and D2 may need to switch antenna configurations during transmission of the HE packets. More specifically, each of devices D1 and D2 may need to switch from a single-antenna transmission to a multi-antenna transmission between the preamble/payload and packet extension of each HE packet. This also may result in the preambles/payload and packet extensions of the HE packets having different transmit power levels. As a result, each of devices D1 and D2 may need to adjust its transmit power from a first level associated with preamble/payload transmissions to a second level associated with packet extension transmissions.

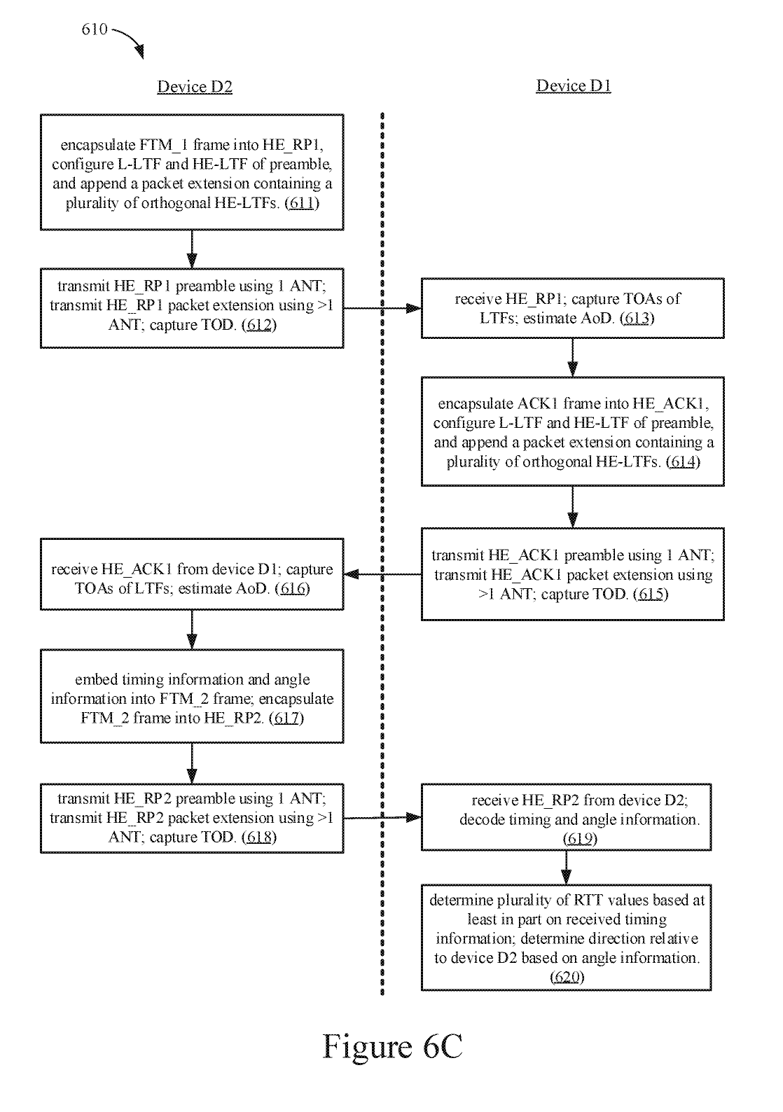

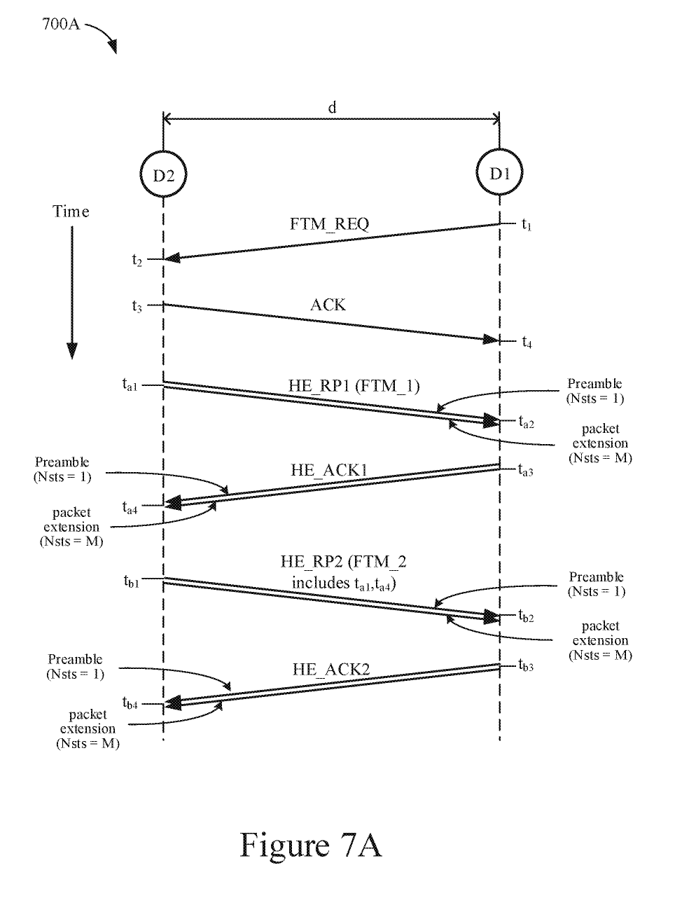

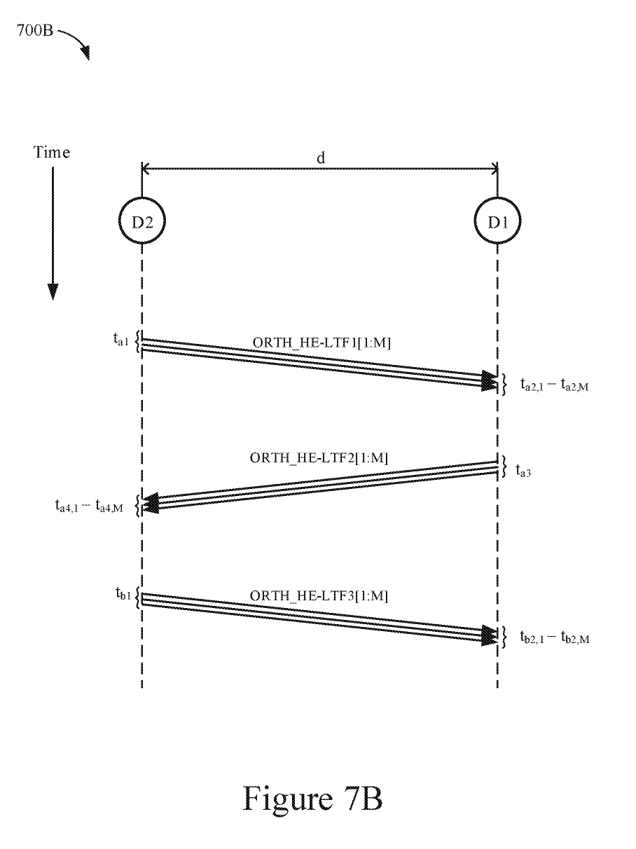

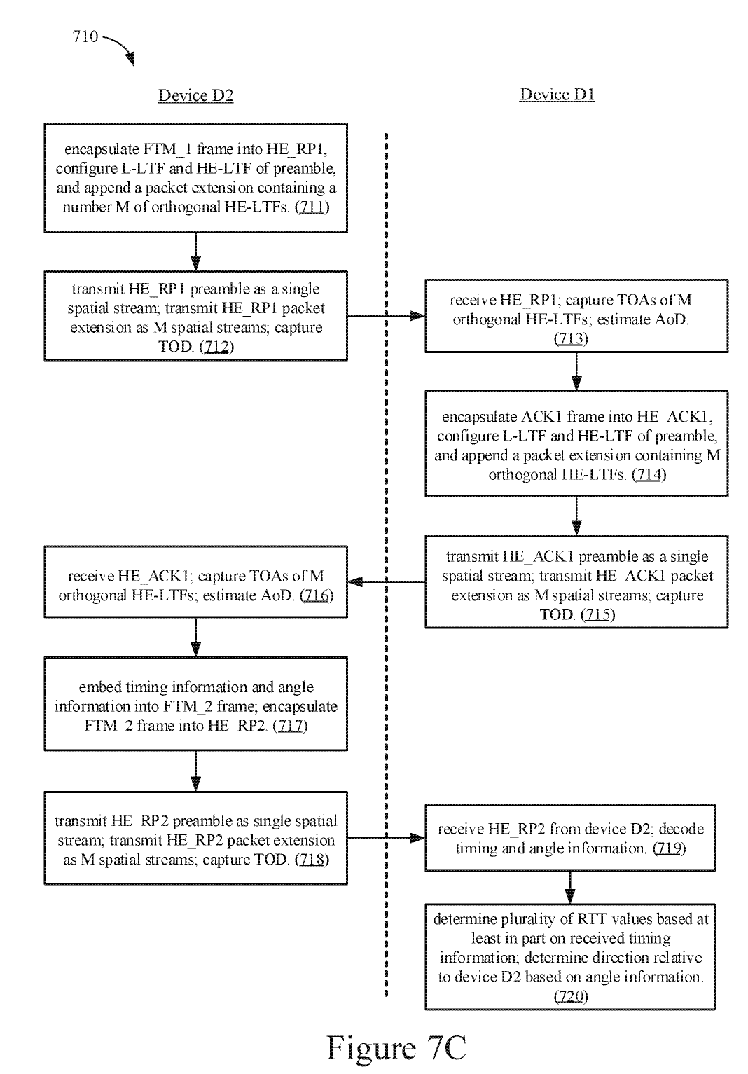

FIG. 7A shows a signal diagram 700A of another example ranging operation, FIG. 7B shows a signal diagram 700B depicting TOD and TOA values of individual LTFs of the example ranging operation of FIG. 7A, and FIG. 7C shows a sequence diagram 710 depicting the example ranging operation of FIG. 7A. The example ranging operation depicted in FIGS. 7A-7C may be performed between a first device D1 and a second device D2. Device D1 and device D2 may each be, for example, an access point (such as the AP 110 of FIG. 1), a station (such as one of the stations STA1-STA4 of FIG. 1), or another suitable wireless device (such as the wireless device 200 of FIG. 2). The example ranging operation of FIG. 7A is similar to the example ranging operation of FIG. 6A, except that for the example ranging operation of FIG. 7A, the preamble and payload of HE packets may be transmitted as a single spatial stream using a plurality of antennas, and the packet extension of HE packets may be transmitted as a plurality of spatial streams using the plurality of antennas.

More specifically, for the example ranging operation of FIG. 7A, device D2 may transmit the preambles and payload of HE ranging packets as a single spatial stream using a number M>1 antennas, and may transmit the packet extensions of HE ranging packets as M spatial streams using M antennas (such as where M is an integer greater than 1). In a similar manner, device D1 may transmit the preambles and payload of HE ACK packets as a single spatial stream using M antennas, and may transmit the packet extensions of HE ACK packets as M spatial streams using M antennas. By transmitting the HE packets using multiple antennas during the example ranging operation of FIG. 7A, device D1 may estimate AoD information for the HE ranging packets transmitted from device D2, and device D2 may estimate AoD information for the HE ACK packets transmitted from device D1.

In addition, because the preambles, payloads, and packet extensions of the HE packets depicted in FIG. 7A are transmitted using the same number of antennas, the preambles, payloads, and packet extensions of the HE packets depicted in FIG. 7A may have the same transmit power levels, for example, thereby avoiding the need to adjust the transmit power during transmission of each HE packet (such as in contrast to the example ranging operation depicted in FIG. 6A).

After the handshake process between times t₁ and t₄ (such as described with respect to FIG. 5A), device D1 and device D2 may being the ranging operation. Specifically, device D2 may encapsulate the FTM_1 frame into a first HE ranging packet (HE_RP1), configure the L-LTF and the HE-LTF of the preamble of HE_RP1, and append a packet extension containing a number M of orthogonal HE-LTFs to HE_RP1 (711). In some aspects, the M orthogonal HE-LTFs may be copies of the HE-LTFs defined for HE NDPs.

Then, at time tₐ₁, device D2 may transmit the preamble and payload of HE_RP1 as a single spatial stream using M antennas, may transmit the packet extension of HE_RP1 as M spatial streams using M antennas, and may capture the TOD of HE_RP1 as time tₐ₁ (712). More specifically, as depicted in FIG. 7B, device D2 may transmit the preamble and payload of HE_RP1 as a single spatial stream, and may then transmit the M orthogonal HE-LTFs in HE_RP1's packet extension as M spatial streams using M antennas.

Device D1 receives HE_RP1 at time tₐ₂, may capture the TOA of HE_RP1 as time tₐ₂, and may estimate AoD information of HE_RP1 (713). Because the preamble of HE_RP1 is transmitted using multiple antennas, device D1 may not be able to accurately estimate the TOAs of the L-LTF and HE-LTF in the preamble of HE_RP1 (such as due to CSD between the multiple transmit antennas of device D1). However, because the HE-LTFs in the packet extension of HE_RP1 are orthogonal to each other, device D1 may be able to distinguish between the multiple HE-LTFs transmitted from device D2 via different spatial streams using a single receiving antenna in a manner that allows device D1 to obtain accurate RTT measurements from each of the HE-LTFs without errors typically associated with CSD. The orthogonal HE-LTFs associated with HE_RP1 may have different TOA values, for example, as described with respect to FIG. 6B.

Device D1 may encapsulate an ACK1 frame into HE_ACK1, configure the L-LTF and the HE-LTF of the preamble of HE_ACK1, and append a packet extension including M orthogonal HE-LTFs to HE_ACK1 (714). In some aspects, the orthogonal HE-LTFs may be copies of the HE-LTFs defined for HE NDPs.

Then, at time tₐ₃, device D1 may transmit the preamble and payload of HE_ACK1 as a single spatial stream using M antennas, may transmit the packet extension of HE_ACK1 as M spatial streams using M antennas, and may capture the TOD of HE_ACK1 as time tₐ₃ (715). More specifically, as depicted in FIG. 7B, device D1 may transmit the preamble and payload of HE_ACK1 as a single spatial stream, and may transmit the M orthogonal HE-LTFs in HE_ACK1's packet extension as M spatial streams using M antennas.

Device D2 receives HE_ACK1 at time tₐ₄, may capture the TOA of HE_ACK1 at time tₐ₄, and may estimate the AoD (716). Because the preamble of HE_ACK1 is transmitted using multiple antennas, device D2 may not be able to accurately estimate the TOAs of the L-LTF and HE-LTF in the preamble of HE_ACK1. However, because the HE-LTFs in the packet extension of HE_ACK1 are orthogonal to each other, device D2 may be able to distinguish between the multiple HE-LTFs transmitted from device D1 via different spatial streams using a single receiving antenna in a manner that allows device D2 to obtain accurate RTT measurements from each of the HE-LTFs without errors typically associated with CSD. The orthogonal HE-LTFs associated with HE_ACK1 may have different TOA values, for example, as described with respect to FIG. 6B.

Device D2 may embed timing information and angle information into an FTM_2 frame, and encapsulate the FTM_2 frame into HE_RP2 (717). The timing information may be indicative of the TOD of the FTM_1 frame encapsulated in HE_RP1 and the TOA of the ACK1 frame encapsulated in HE_ACK1. In some aspects, the TOA (tₐ₄) reported by device D2 to device D1 may be based on (such as an average of) the TOAs of the HE-LTFs received with the ACK1 frame (device D2 may use any suitable algorithm for selecting an accurate TOA value for tₐ₄). The angle information may include the estimated AoD of HE_ACK1 transmitted from device D1. In some aspects, the angle information also may include the estimated AoA of HE_ACK1 received at device D2.

Then, at time t_{b1}, device D2 may transmit the preamble and payload of HE_RP2 as a single spatial stream using M antennas, may transmit the packet extension of HE_RP2 as M spatial streams using M antennas, and may capture the TOD of HE_RP2 as time t_{b1} (718). More specifically, as depicted in FIG. 7B, device D2 may transmit the preamble and payload of HE_RP2 as a single spatial stream, and may transmit the M orthogonal HE-LTFs in HE_RP2's packet extension as M spatial streams using M antennas.

Device D1 receives HE_RP2 at time t_{b2}, and decodes the timing information and the angle information embedded therein (719). In some implementations, device D1 may capture the TOA of HE_RP2 as time t_{b2}. Because the preamble of HE_RP2 is transmitted using multiple antennas, device D1 may not be able to accurately estimate the TOAs of the L-LTF and HE-LTF in the preamble of HE_RP2. Even if device D1 uses a single antenna to receive the plurality of HE-LTFs in the packet extension of HE_RP2, device D1 may distinguish between the channels associated with the different transmit antennas of device D2, for example, because the HE-LTFs are orthogonal to each other. By using the channels associated with the different transmit antennas of device D2, device D1 can estimate AoD information. In some aspects, the orthogonal HE-LTFs associated with HE_RP2 may have different TOA values, for example, as described with respect to FIG. 6B.

Upon receiving HE_RP2 at time t_{b2}, device D1 has a timestamp value for time tₐ₁ that corresponds to the TOD of HE_RP1 transmitted from device D2, has timestamp values for times t_{a2,1}-t_{a2,M} that correspond to the TOAs of the M orthogonal HE-LTFs in HE_RP1 received at device D1, has a timestamp value for time tₐ₃ that corresponds to the TOD of the HE_ACK1 transmitted from device D1, and has a timestamp value for time tₐ₄ that corresponds to the TOA of the HE_ACK1 received at device D2.

Thereafter, device D1 may determine a plurality of RTT values based on the aforementioned timestamp values, and may determine its direction relative to device D2 (such as based on the AoA or AoD information embedded in the FTM_2 frame) (720). More specifically, device D1 may determine a first RTT value based on the exchange of a first pair of orthogonal HE-LTFs (such as ORTH_HE-LTF1[1] and ORTH_HE-LTF2[1]) as RTT1=(tₐ₄−tₐ₃) (t_{a2,1}−tₐ₁), may determine a second RTT value based on the exchange of a second pair of orthogonal HE-LTFs (such as ORTH_HE-LTF1[2] and ORTH_HE-LTF2[2]) as RTT1=(tₐ₄−tₐ₃)+(t_{a2,2}−tₐ₁), and so on.

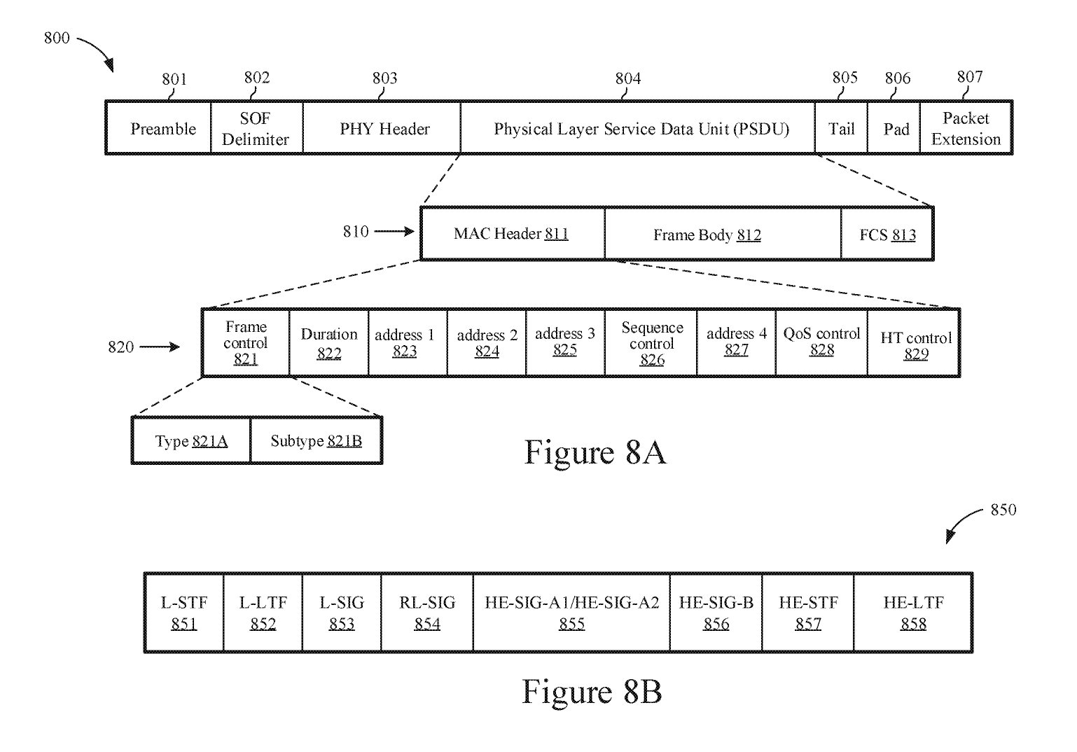

FIG. 8A shows an example packet 800. The packet 800 may be an implementation of the ranging packets used in the example ranging operations described with respect to FIGS. 5A-5C, 6A-6C, and 7A-7C. The packet 800 is shown to include a preamble 801, a start of frame (SOF) delimiter 802, a physical-layer (PHY) header 803, a Physical Layer Service Data Unit (PSDU) 804, a tail field 805, a pad field 806, and a packet extension 807, for example, as defined in the IEEE 802.11 standards.

The preamble 801 may include synchronization information, timing information, frequency offset correction information, and signaling information, for example, as described in more detail with respect to FIG. 8B. The SOF delimiter 802 may indicate the start of the data frame encapsulated within the packet 800. The PHY header 803 may include a number of fields for storing data rates, a reserved bit, a length of the PSDU 804, a parity bit, a number of tail bits, and service information. The PSDU 804 may contain a MAC Protocol Data Unit (MPDU) 810. The tail field 805 may include a number of tail bits, and the pad field 806 may include a number of pad bits.

The MPDU 810, which may be commonly referred to as a MAC frame, may be compliant with the IEEE 802.11 family of standards. The MPDU 810 includes a MAC header 811, a frame body 812, and a frame control sequence (FCS) field 813. The MAC header 811 may include a number of fields containing information that describes characteristics or attributes of data encapsulated within the frame body 812, may include a number of fields indicating source and destination addresses of the data encapsulated within the frame body 812, and may include a number of fields containing control information. In some implementations, the MAC header 811 may be used as the MAC header of any suitable data frame, control frame, management frame, and action frame (such as the FTM frames and the ACK frames used in the example ranging operations of FIGS. 5A, 6A, and 7A).

More specifically, FIG. 8A also shows a MAC header 820 that may be an implementation of the MAC header 811 of the MPDU 810. The MAC header 820 may include a frame control field 821, a duration field 822, an address 1 field 823, an address 2 field 824, an address 3 field 825, a sequence control field 826, an address 4 field 827, a Quality of Service (QoS) control field 828, and a high-throughput (HT) control field 829. The frame control field 821 includes a Type field 821A and a Sub-type field 821B. The Type field 821A may store a value indicating whether the MAC frame is a control frame, a data frame, or a management frame, and the Sub-type field 821B may store a value indicating a type of control frame, data frame, or management frame.

The duration field 822 may store the value of the Network Allocation Vector (NAV). The address 1 field 823 may store the MAC address of the receiving device, the address 2 field 824 may store the MAC address of the transmitting device, and the address 3 field 825 may be used for filtering (such as by an AP). The sequence control field 826 may store sequence information (such as used for data re-transmissions). The address 4 field 827 may store mesh address information. The QoS control field 828 may store optional QoS control information (such as a traffic class), and the HT control field 829 may store information for high-throughput packets. In some implementations, the frame control field 821 is 2 bytes, the duration field 822 is 2 bytes, the address 1 field 832 is 6 bytes, the address 2 field 824 is 6 bytes, the address 3 field 825 is 6 bytes, the sequence control field 826 is 2 bytes, the address 4 field 827 is 0 or 6 bytes, the QoS control field 828 is 0 or 2 bytes, and the HT field 829 is 0 or 4 bytes. In some other implementations, the fields of the MAC header 811 of FIG. 8A may be of other suitable lengths.

The packet extension 807 does not typically store any data. Instead, the packet extension 807 typically stores “dummy” data (such as repeating the last symbol of the packet payload), for example, to allow a receiving device more time to decode the packet 800 without giving up medium access granted to a transmitting device. In accordance with the subject matter described in this disclosure, the packet extension 807 may be used to store one or more HE-LTFs. These one or more HE-LTFs may be used to provide additional RTT measurements, for example, as described with respect to FIGS. 5A-5C, 6A-6C, and 7A-7C. In some aspects, the one or more HE-LTFs stored in the packet extension 807 may be copies of the HE-LTF provided within the preamble 801, as described in more detail with respect to FIG. 8B.

In some implementations, the packet extension 807 may have a maximum transmit duration of 16 microseconds, and each of the HE-LTFs may have a maximum transmit duration of 4 microseconds. As such, the packet extension 807 may be able to contain four of the HE-LTFs. Referring also to FIGS. 5A, 6A, and 7A, if devices D1 and D2 each include 8 antennas, then each of devices D1 and D2 may use a first set of four antennas to exchange the first ranging packets and the first ACK packets (such as HE_RP1 and HE_ACK1), and may use a second set of four antennas to exchange the second ranging packets and the second ACK packets (such as HE_RP2 and HE_ACK2). In this manner, devices D1 and D2 may obtain channel information associated with all 8 transmit antennas of each other, which in turn may improve the accuracy with which AoD information may be estimated.

In some other implementations, the maximum transmit duration of each of the HE-LTFs may be adjusted based on the configuration of the HE-LTFs. In some aspects, the maximum transmit duration of each of the HE-LTFs may be 4 us, for example, when using a 1× HE-LTF configuration (such as because four 4 us-long HE-LTFs may fit within in a 16 us-long PE). The four 4 us-long HE-LTFs may be transmitted from a first set of 4 antennas, and may be transmitted from a second set of 4 antennas using a CSD value (such as 200 us). In other aspects, the maximum transmit duration of each of the HE-LTFs may be Bus, for example, when using a 2× HE-LTF configuration (such as because two Bus-long HE-LTFs may fit within in a 16 us-long PE). The two Bus-long HE-LTFs may be transmitted from a first set of 2 antennas, may be transmitted from a second set of 2 antennas using a first CSD value (such as 200 us), may be transmitted from a third set of 2 antennas using a second CSD value (such as 400 us), and may be transmitted from a fourth set of 2 antennas using a third CSD value (such as 600 us). In some other aspects, the maximum transmit duration of the HE-LTF may be 16 us, for example, when using a 4× HE-LTF configuration (such as because one 16 us-long HE-LTF may fit within in a 16 us-long PE). The one 16 us-long HE-LTF may be transmitted from each antenna using a CSD value applied between antennas (such as by transmitting the one 16 us-long HE-LTF from a first antenna, transmitting the one 16 us-long HE-LTF from a second antenna using a first CSD value, transmitting the one 16 us-long HE-LTF from a third antenna using a second CSD value, and so on).

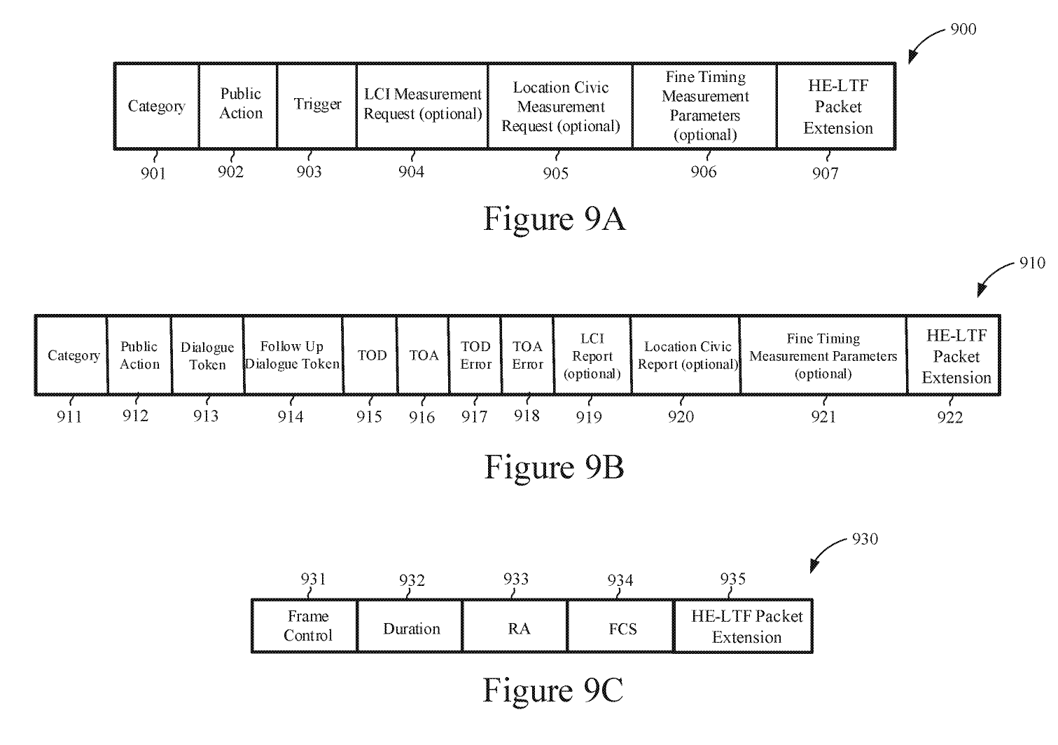

An antenna mask may be added to the FTM frames, for example, by using a number of reserved bits in the FTM frames. Referring also to FIG. 9B, a number of the reserved bits in the TOD error and TOA error fields of the FTM frame 910 may be used to store the antenna mask. In some implementations, the number of bits in the antenna mask may correspond to the number of antennas of the transmitting device. For example, if the transmitting device includes 8 antennas, then the antenna mask may include 8 bits, each indicating whether a corresponding one of the 8 antennas is used to transmit the FTM frame. In some aspects, a bit value of “1” may indicate that the corresponding antenna is used to transmit the FTM frame, and a bit value of “0” may indicate that the corresponding antenna is not used to transmit the FTM frame.

For one example, if the transmitting device uses the first set of four antennas to transmit the FTM frame, then the antenna mask transmitted with the FTM frame may be “00001111” to indicate that the first set of four antennas is used and the second set of four antennas is not used. For another example, if the transmitting device uses the second set of four antennas to transmit the FTM frame, then the antenna mask transmitted with the FTM frame may be “11110000” to indicate that the second set of four antennas is used and the first set of four antennas is not used.

FIG. 8B shows an example high efficiency (HE) preamble 850. The HE preamble 850 may be one implementation of the preamble 801 of the packet 800 of FIG. 8A, and may be compliant with the IEEE 802.11 standards. For example, an FTM_REQ frame, an FTM action frame, or an ACK frame may be encapsulated within the PSDU 804 of the packet 800 of FIG. 8A. The preamble 850, which in some aspects may be compliant with the IEEE 802.11ax standards, is shown to include a Legacy Short Training Field (L-STF) 851, a Legacy Long Training Field (L-LTF) 852, a Legacy Signal (L-SIG) field 853, a Repeated Legacy Signal (RL-SIG) field 854, a set of HE Signal-A (HE-SIG-A1/HE-SIG-A2) fields 855, an HE Signal B (HE-SIG-B) field 856, an HE Short Training Field (HE-STF) 857, and an HE Long Training Field (HE-LTF) 858.

The L-STF 851 may include information for coarse frequency estimation, automatic gain control, and timing recovery. The L-LTF 852 may include information for fine frequency estimation, channel estimation, and fine timing recovery. In some implementations, the L-LTF 852 may include information from which an RTT measurement may be determined, for example, as described with respect to FIGS. 5A-5C and 6A-6C.

The L-SIG field 853 may include modulation and coding information. The HE-SIG-A1 and HE-SIG-A2 fields 855 may include parameters such as an indicated bandwidth, a payload guard interval (GI), a coding type, a number of spatial streams (Nsts), a space-time block coding (STBC), beamforming information, and so on.

More specifically, the HE-SIG-A1 and HE-SIG-A2 fields 855 may include a set of fields to store parameters describing the type of information stored in the HE-LTF 858 (such as whether the HE-LTF 858 is configured with information from which a receiving device may obtain an RTT measurement). For example, the set of fields includes (1) a CP+LTF Size field that stores a cyclic prefix (CP) value and a length of the HE-LTF 858; (2) an Nsts field to store information indicating the number spatial streams, (3) a STBC field store a value for space-time block coding, and (4) a transmit beamforming (TxBF) field to store information pertaining to beamforming.

Information contained in the HE-STF 857 may be used to improve automatic gain control estimates for SU-MIMO and MU-MIMO communications, and information contained in the HE-LTF 858 may be used to estimate various MIMO channel conditions. More specifically, in some implementations, the HE-LTF 858 may include information from which an RTT measurement may be determined, for example, as described with respect to FIGS. 5A-5C and 6A-6C. In some aspects, one or more copies of the HE-LTF 858 may be provided within the packet extension 807 of the packet 800.

In some implementations, the HE-SIG-A1 and HE-SIG-A2 fields 855 may include an extra bit to indicate whether the packet extension 807 of the packet 800 includes an HE-LTF. In some aspects, the extra bit may store a “1” to indicate that the packet extension 807 contains an HE-LTF, and may store a “0” to indicate that the packet extension 807 does not contain an HE-LTF.

More specifically, for the example ranging operation of FIG. 5A, the HE ranging packets and the HE ACK packets are each transmitted using a single antenna, and therefore the packet extensions of the HE ranging packets and the HE ACK packets of FIG. 5A each may include one additional HE-LTF. Thus, when the packet 800 is used to form the HE ranging packets and the HE ACK packets of the ranging operation of FIG. 5A, the extra bit in the HE-SIG-A1 and HE-SIG-A2 fields 855 may indicate whether the packet extension 807 includes an HE-LTF.

For the example ranging operation of FIG. 6A, the preambles and the payload of the HE ranging packets and the HE ACK packets are transmitted using a single antenna, and the packet extensions of the HE ranging packets and the HE ACK packets are transmitted using multiple antennas. Thus, the packet extensions of the HE ranging packets and the HE ACK packets of FIG. 6A each may include more than one HE-LTF. In some aspects, the number of HE-LTFs to be included within the packet extension 807 of the packet 800 may be based on the number of antennas or on the number of spatial streams (Nsts) used to transmit the packet extension 807. Thus, when the packet 800 is used to form the HE ranging packets and the HE ACK packets of the ranging operation of FIG. 6A, the extra bit in the HE-SIG-A1 and HE-SIG-A2 fields 855 may indicate whether the packet extension 807 includes a number of HE-LTFs.

The HE-LTFs contained in the packet extensions of the HE ranging packets and the HE ACK packets of the ranging operation of FIG. 6A may be based on the HE-LTFs used in HE NDPs (which are designed for wideband channel sounding operations). For these ranging packets, the HE-SIG-A1 and HE-SIG-A2 fields 855 may be modified to include a number of extra sets of fields to store parameters for the NDP-based HE-LTFs contained in the packet extension 807.

In some aspects, each of these extra sets of fields may be of a similar format as the set of fields described with respect to the HE-LTF 858. For each extra set of fields (in the HE-SIG-A1 and HE-SIG-A2 fields 855) that describes a corresponding NDP-based HE-LTF contained in packet extension 807, the Nsts field stores information indicating the number of spatial streams used to transmit the NDP-based HE-LTF, the STBC stores a value that disables space-time block coding, and the TxBF field stores a value that disables beamforming (because using a beamforming matrix to transmit the NDP-based HE-LTF may change the channel information as seen by the receiving device).

In some other aspects, one or more fields in each of the extra sets of field may be eliminated to minimize packet length. For example, the CP+LTF Size field may be removed by mandating that the CP+LTF Size in the packet extension 807 is the same as in the preamble 801. For another example, the STBC field may be removed by mandating that space-time block coding is to be disabled. For another example, the TxBF field may be removed by mandating that beamforming is to be disabled.

FIG. 9A shows an example FTM_REQ frame 900. The FTM_REQ frame 900 may be used in the example ranging operations of Figures SA, 6A, and 7A. The FTM_REQ frame 900 may include a category field 901, a public action field 902, a trigger field 903, an optional location civic information (LCI) measurement request field 904, an optional location civic measurement request field 905, an optional FTM parameters field 906, and an HE-LTF packet extension 907. The fields 901-906 of the FTM_REQ frame 900 are known by persons having ordinary skill in the art, and therefore are not discussed in detail herein. In some aspects, the HE-LTF packet extension 907 may be one implementation of the packet extension 807 of the packet 800 of FIG. 8A.

FIG. 9B depicts an example FTM frame 910. The FTM frame 910 may be used in the example ranging operations of Figures SA, 6A, and 7A. The FTM frame 910 may include a category field 911, a public action field 912, a dialog token field 913, a follow up dialog token field 914, a TOD field 915, a TOA field 916, a TOD error field 917, a TOA error field 918, an optional LCI report field 919, an optional location civic report field 920, an optional FTM parameters field 921, and an HE-LTF packet extension 922. The fields 911-921 of the FTM frame 910 are known by persons having ordinary skill in the art, and therefore are not discussed in detail herein. The HE-LTF packet extension 922 may be one implementation of the packet extension 807 of the packet 800 of FIG. 8A. A number of reserved bits in the TOD error field 917 and the TOA error field 918 of the FTM frame 910 may be used to store an antenna mask.

FIG. 9C shows an example ACK frame 930. In some aspects, the ACK frame 930 may be used as the ACK frames depicted in the example ranging operations of FIGS. 5A, 6A, and 7A. The ACK frame 930 may include a 2-byte frame control field 931, a 2-byte duration field 932, a 6-byte receiver address (RA) field 933, a 4-byte frame check sequence (FCS) field 934, and an HE-LTF packet extension 935. Although not shown in FIG. 9C for simplicity, the frame control field 931 may include a 2-bit frame Type field and a 4-bit Sub type field that together may store information indicating that the example frame 930 of FIG. 9C is an ACK frame. In some other implementations, the field lengths of the example ACK frame 930 may be of other suitable values. The duration field 932 stores a value indicating a length of the ACK frame 930, the RA field 933 stores an address identifying the recipient of the ACK frame 930, and the FCS field 934 stores a frame check sequence. The HE-LTF packet extension 935 may be one implementation of the packet extension 807 of the packet 800 of FIG. 8A.

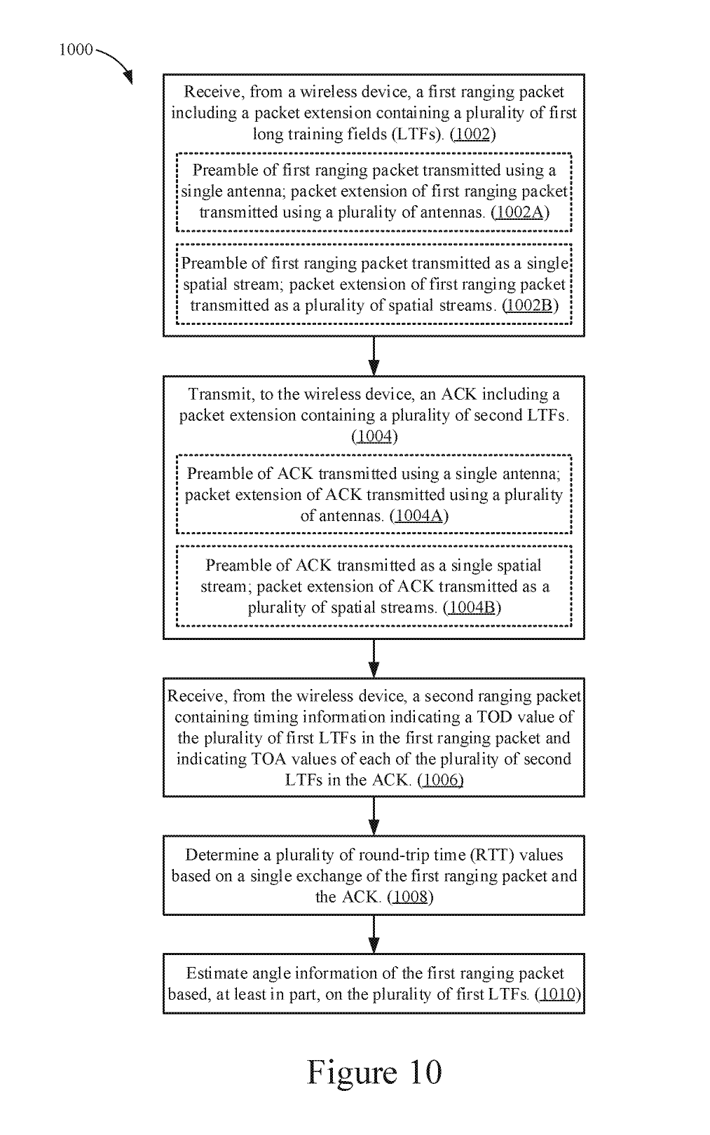

FIG. 10 shows an illustrative flow chart depicting an example ranging operation 1000. The example ranging operation 1000 is performed between a first device D1 and a second device D2. The first device D1 and the second device D2 each may be, for example, an access point (such as the AP 110 of FIG. 1), a station (such as one of the stations STA1-STA4 of FIG. 1), or other suitable wireless device (such as the wireless device 200 of FIG. 2).

The first device D1 may receive, from the second device D2, a first ranging packet including a packet extension containing a plurality of first long training fields (LTFs) (1002). In some implementations, the first ranging packet can be a first fine timing measurement (FTM) frame transmitted using a high efficiency (HE) frame format. The preamble of the first ranging packet can include a HE signaling field indicating that the packet extension of the first ranging packet contains the plurality of first LTFs. In some aspects, the preamble of the first ranging packet can be transmitted using a single antenna, and the packet extension of the first ranging packet can be transmitted using a plurality of antennas (1002A). In some other aspects, the preamble of the first ranging packet can be transmitted as a single spatial stream, and the packet extension of the first ranging packet can be transmitted as a plurality of spatial streams (1002B).

The first device D1 may transmit, to the second device D2, an acknowledgement (ACK) including a packet extension containing a plurality of second LTFs (1004). In some implementations, the ACK can be transmitted using a high efficiency (HE) frame format. The preamble of the ACK can include a HE signaling field indicating that the packet extension of the ACK contains the plurality of second LTFs. In some aspects, the preamble of the ACK can be transmitted using a single antenna, and the packet extension of the ACK can be transmitted using a plurality of antennas (1004A). In some other aspects, the preamble of the ACK can be transmitted as a single spatial stream, and the packet extension of the ACK can be transmitted as a plurality of spatial streams (1004B).

In some implementations, the plurality of first LTFs and the plurality of second LTFs can be high-efficiency long training fields (HE-LTFs). The HE-LTFs can be orthogonal to each other. In some aspects, the HE-LTFs can be based on (or derived from) a high-efficiency null data packet (HE NDP), for example, as used in MIMO channel sounding operations. In some other implementations, other suitable LTFs can be used (such as VHT-LTFs, HT-LTFs, and legacy LTFs).

Transmitting the preamble of the first ranging packet using a single antenna may allow receiving devices (such as the first device D1) having one antenna to decode the first ranging packet, and transmitting the packet extension of the first ranging packet using a plurality of antennas may allow receiving devices (such as the first device D1) to estimate AoD information of the first ranging packet. Similarly, transmitting the preamble of the ACK using a single antenna may allow receiving devices (such as the second device D2) having one antenna to decode the ACK, and transmitting the packet extension of the ACK using a plurality of antennas may allow receiving devices (such as the second device D2) to estimate AoD information of the ACK. In addition, if the first device D1 uses multiple antennas to receive the first ranging packet, then the first device D1 can estimate AoA information of the first ranging packet. Similarly, if the second device D2 uses multiple antennas to receive the ACK, then the second device D2 can estimate AoA information of the ACK.

The first device D1 may receive, from the second device D2, a second ranging packet containing timing information indicating a time of departure (TOD) value of the plurality of first LTFs in the first ranging packet and indicating a time of arrival (TOA) value of each of the plurality of second LTFs in the ACK (1006). In some implementations, the second ranging packet can be a second FTM frame transmitted from the second device D2 using the HE frame format. Further, as described with respect to FIGS. 6A-6C, each of the plurality of second LTFs in the ACK may have a slightly different TOA value, and therefore the second ranging packet may include a plurality of different TOA values associated with the first ranging packet and the ACK.

The first device D1 may determine a plurality of round-trip time (RTT) values based on a single exchange of the first ranging packet and the ACK (1008). For example, the first device D1 may determine a first RTT value based at least in part on the TOD value of the plurality of first LTFs and the TOA value of a first one of the plurality of second LTFs, may determine a second RTT value based at least in part on the TOD value of the plurality of first LTFs and the TOA value of a second one of the plurality of second LTFs, may determine a third RTT value based at least in part on the TOD value of the plurality of first LTFs and the TOA value of a third one of the plurality of second LTFs, and so on, as described with respect to FIGS. 6A-6C.

Thereafter, the first device D1 may estimate angle information of the first ranging packet based, at least in part, on the plurality of first LTFs contained in the first ranging packet (1010). For example, because the plurality of first LTFs are transmitted from multiple antennas of the second device D2, the first device D1 can use phase differences of the first ranging packet, as measured between the multiple antennas of the second device D2, to estimate AoD information of the first ranging packet. If the first device D1 uses multiple antennas to receive the first ranging packet, then the first device D1 can use phase differences of the first ranging packet, as measured between the multiple antennas of the first device D1, to estimate AoA information of the first ranging packet.

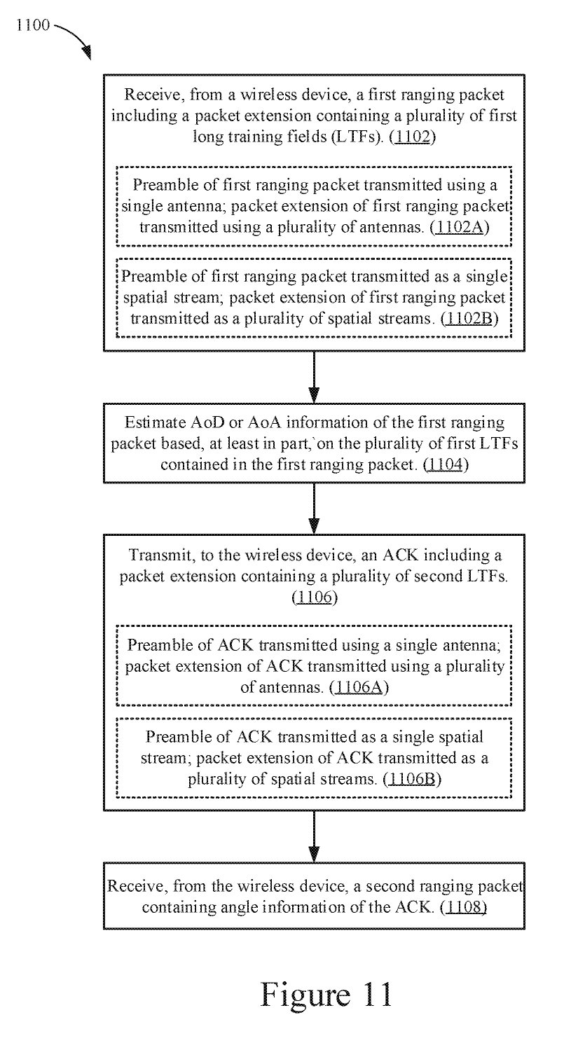

FIG. 11 shows an illustrative flow chart depicting another example ranging operation 1100. The example ranging operation 1100 is performed between a first device D1 and a second device D2. The first device D1 and the second device D2 each may be, for example, an access point (such as the AP 110 of FIG. 1), a station (such as one of the stations STA1-STA4 of FIG. 1), or other suitable wireless device (such as the wireless device 200 of FIG. 2).

The first device D1 may receive, from the second device D2, a first ranging packet including a packet extension containing a plurality of first long training fields (LTFs) (1102). In some implementations, the first ranging packet can be an FTM frame transmitted using the HE frame format. The preamble of the first ranging packet can include a HE signaling field indicating that the packet extension of the first ranging packet contains the plurality of first LTFs. In some aspects, the preamble of the first ranging packet can be transmitted using a single antenna, and the packet extension of the first ranging packet can be transmitted using a plurality of antennas (1102A). In some other aspects, the preamble of the first ranging packet can be transmitted as a single spatial stream, and the packet extension of the first ranging packet can be transmitted as a plurality of spatial streams (1102B).

The first device D1 may estimate AoD or AoA information of the first ranging packet based, at least in part, on the plurality of first LTFs contained in the first ranging packet (1104). In some aspects, the plurality of first LTFs in the packet extension of the first ranging packet can be orthogonal HE-LTFs transmitted using multiple antennas of the second device D2, which can allow the first device D1 to estimate the AoD of the first ranging packet. Further, if the first device D1 uses multiple antennas to receive the first ranging packet, then the first device D1 can estimate AoA information of the first ranging packet.

The first device D1 may transmit, to the second device D2, an ACK including a packet extension containing a plurality of second LTFs (1106). In some implementations, the ACK can be transmitted using a high efficiency (HE) frame format. The preamble of the ACK can include a HE signaling field indicating that the packet extension of the ACK contains the plurality of second LTFs. In some aspects, the preamble of the ACK can be transmitted using a single antenna, and the packet extension of the ACK can be transmitted using a plurality of antennas (1106A). In some other aspects, the preamble of the ACK can be transmitted as a single spatial stream, and the packet extension of the ACK can be transmitted as a plurality of spatial streams (1106B).

In some implementations, the plurality of first LTFs and the plurality of second LTFs can be high-efficiency long training fields (HE-LTFs). The HE-LTFs can be orthogonal to each other. In some aspects, the HE-LTFs can be based on (or derived from) a high-efficiency null data packet (HE NDP), for example, as used in MIMO channel sounding operations. In some other implementations, other suitable LTFs can be used (such as VHT-LTFs, HT-LTFs, and legacy LTFs).

The first device D1 may receive, from the second device D2, a second ranging packet containing angle information of the ACK (1108). In some aspects, the angle information can include an estimated AoD value of the plurality of second LTFs in the packet extension of the ACK, and can include estimated AoA values of the plurality of second LTFs in the packet extension of the ACK.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of performing a ranging operation, comprising:
receiving, from a wireless device, a first ranging packet including a packet extension containing a plurality of first long training fields (LTFs);
transmitting, to the wireless device, an acknowledgement (ACK) including a packet extension containing a plurality of second LTFs;
receiving, from the wireless device, a second ranging packet containing timing information indicating a time of departure (TOD) value of the plurality of first LTFs in the first ranging packet and indicating a time of arrival (TOA) value of each of the plurality of second LTFs in the ACK; and
determining a plurality of round-trip time (RTT) values based on a single exchange of the first ranging packet and the ACK.

2. The method of claim 1, wherein the first ranging packet includes a first fine timing measurement (FTM) frame transmitted using a high efficiency (HE) frame format, and the second ranging packet includes a second FTM frame transmitted using the HE frame format.

3. The method of claim 2, wherein:
a first HE signaling field, provided within a preamble of the first ranging packet, indicates that the packet extension of the first ranging packet contains the plurality of first LTFs; or
a second HE signaling field, provided within a preamble of the ACK, indicates that the packet extension of the ACK contains the plurality of second LTFs.

4. The method of claim 1, wherein:
a preamble of the ACK is transmitted using a single antenna, and the packet extension of the ACK is transmitted using a plurality of antennas; or
a preamble of the first ranging packet is transmitted using a single antenna, and the packet extension of the first ranging packet is transmitted using a plurality of antennas.

5. The method of claim 1, wherein:
a preamble of the ACK is transmitted as a single spatial stream, and the packet extension of the ACK is transmitted as a plurality of spatial streams; or
a preamble of the first ranging packet is transmitted as a single spatial stream, and the packet extension of the first ranging packet is transmitted as a plurality of spatial streams.

6. The method of claim 1, wherein the plurality of first LTFs and the plurality of second LTFs each include a set of orthogonal high-efficiency long training fields (HE-LTFs).

7. The method of claim 1, wherein:
a first of the plurality of RTT values is based, at least in part, on the TOD value of the plurality of first LTFs and the TOA value of a first one of the plurality of second LTFs; and
a second of the plurality of RTT values is based, at least in part, on the TOD value of the plurality of first LTFs and the TOA value of a second one of the plurality of second LTFs.

8. The method of claim 1, further comprising:
estimating an angle of departure (AoD) or an angle of arrival (AoA) of the first ranging packet based, at least in part, on the plurality of first LTFs contained in the packet extension of the first ranging packet.

9. The method of claim 1, wherein the second ranging packet further includes angle information of the ACK.

10. The method of claim 9, wherein the angle information is at least one of estimated AoD values of the plurality of second LTFs in the packet extension of the ACK and estimated angle of arrival (AoA) values of the plurality of second LTFs in the packet extension of the ACK.

11. An apparatus for performing a ranging operation, comprising:
one or more processors; and
a memory comprising instructions that, when executed by the one or more processors, causes the apparatus to:
receive, from a wireless device, a first ranging packet including a packet extension containing a plurality of first long training fields (LTFs);
transmit, to the wireless device, an acknowledgement (ACK) including a packet extension containing a plurality of second LTFs;
receive, from the wireless device, a second ranging packet containing timing information indicating a time of departure (TOD) value of the plurality of first LTFs in the first ranging packet and indicating a time of arrival (TOA) value of each of the plurality of second LTFs in the ACK; and
determine a plurality of round-trip time (RTT) values based on a single exchange of the first ranging packet and the ACK.

12. The apparatus of claim 11, wherein the first ranging packet includes a first fine timing measurement (FTM) frame transmitted using a high efficiency (HE) frame format, and the second ranging packet includes a second FTM frame transmitted using the HE frame format.

13. The apparatus of claim 12, wherein:
a first HE signaling field, provided within a preamble of the first ranging packet, indicates that the packet extension of the first ranging packet contains the plurality of first LTFs; or
a second HE signaling field, provided within a preamble of the ACK, indicates that the packet extension of the ACK contains the plurality of second LTFs.

14. The apparatus of claim 11, wherein:
a preamble of the ACK is transmitted using a single antenna, and the packet extension of the ACK is transmitted using a plurality of antennas; or
a preamble of the first ranging packet is transmitted using a single antenna, and the packet extension of the first ranging packet is transmitted using a plurality of antennas.

15. The apparatus of claim 11, wherein:
a preamble of the ACK is transmitted as a single spatial stream, and the packet extension of the ACK is transmitted as a plurality of spatial streams; or
a preamble of the first ranging packet is transmitted as a single spatial stream, and the packet extension of the first ranging packet is transmitted as a plurality of spatial streams.

16. The apparatus of claim 11, wherein the plurality of first LTFs and the plurality of second LTFs each include a set of orthogonal high-efficiency long training fields (HE-LTFs).

17. The apparatus of claim 11, wherein:
a first of the plurality of RTT values is based, at least in part, on the TOD value of the plurality of first LTFs and the TOA value of a first one of the plurality of second LTFs; and
a second of the plurality of RTT values is based, at least in part, on the TOD value of the plurality of first LTFs and the TOA value of a second one of the plurality of second LTFs.

18. The apparatus of claim 11, wherein execution of the instructions causes the apparatus to further:
estimate an angle of departure (AoD) or an angle of arrival (AoA) of the first ranging packet based, at least in part, on the plurality of first LTFs contained in the packet extension of the first ranging packet.

19. The apparatus of claim 11, wherein the second ranging packet further includes angle information of the ACK.

20. The apparatus of claim 19, wherein the angle information is at least one of estimated AoD values of the plurality of second LTFs in the packet extension of the ACK and estimated angle of arrival (AoA) values of the plurality of second LTFs in the packet extension of the ACK.

21. A non-transitory computer-readable medium comprising instructions that, when executed by an apparatus, cause the apparatus to perform a ranging operation by:
receiving, from a wireless device, a first ranging packet including a packet extension containing a plurality of first long training fields (LTFs);
transmitting, to the wireless device, an acknowledgement (ACK) including a packet extension containing a plurality of second LTFs;
receiving, from the wireless device, a second ranging packet containing timing information indicating a time of departure (TOD) value of the plurality of first LTFs in the first ranging packet and indicating a time of arrival (TOA) value of each of the plurality of second LTFs in the ACK; and
determining a plurality of round-trip time (RTT) values based on a single exchange of the first ranging packet and the ACK.

22. The non-transitory computer-readable medium of claim 21, wherein:
a first of the plurality of RTT values is based, at least in part, on the TOD value of the plurality of first LTFs and the TOA value of a first one of the plurality of second LTFs; and
a second of the plurality of RTT values is based, at least in part, on the TOD value of the plurality of first LTFs and the TOA value of a second one of the plurality of second LTFs.

23. The non-transitory computer-readable medium of claim 21, wherein execution of the instructions causes the apparatus to further:
estimate an angle of departure (AoD) or an angle of arrival (AoA) of the first ranging packet based, at least in part, on the plurality of first LTFs contained in the packet extension of the first ranging packet.

24. The non-transitory computer-readable medium of claim 21, wherein the second ranging packet further includes angle information of the ACK, and execution of the instructions causes the apparatus to further:
estimate a location of the wireless device based, at least in part, on the plurality of RTT values and the angle information.

25. A method of performing a ranging operation, comprising:
receiving, from a wireless device, a first ranging packet including a packet extension containing a plurality of first long training fields (LTFs); and
estimating an angle of departure (AoD) or an angle of arrival (AoA) of the first ranging packet based, at least in part, on the plurality of first LTFs contained in the packet extension of the first ranging packet.

26. The method of claim 25, further comprising:
transmitting, to the wireless device, an acknowledgement (ACK) including a packet extension containing a plurality of second LTFs; and
receiving, from the wireless device, a second ranging packet containing angle information of the ACK.

27. The method of claim 26, wherein the angle information is at least one of estimated AoD values of the plurality of second LTFs in the packet extension of the ACK and estimated angle of arrival (AoA) values of the plurality of second LTFs in the packet extension of the ACK.

28. The method of claim 26, wherein:
a preamble of the ACK is transmitted using a single antenna, and the packet extension of the ACK is transmitted using a plurality of antennas; or
a preamble of the first ranging packet is transmitted using a single antenna, and the packet extension of the first ranging packet is transmitted using a plurality of antennas.

29. The method of claim 26, wherein:
a preamble of the ACK is transmitted as a single spatial stream, and the packet extension of the ACK is transmitted as a plurality of spatial streams; or
a preamble of the first ranging packet is transmitted as a single spatial stream, and the packet extension of the first ranging packet is transmitted as a plurality of spatial streams.

30. The method of claim 26, wherein the plurality of first LTFs and the plurality of second LTFs each include a set of orthogonal high-efficiency long training fields (HE-LTFs).
